(19) United States
(12) Patent Application Publication
(10) Pub. No.: US 2023/0345509 A1
(43) Pub. Date: Oct. 26, 2023

(54) MULTICAST/BROADCAST SERVICE ALERT

(71) Applicant: QUALCOMM Incorporated, San Diego, CA (US)

(72) Inventors: Prasad Reddy KADIRI, San Diego, CA (US); Le LIU, San Jose, CA (US); Xipeng ZHU, San Diego, CA (US); Miguel GRIOT, La Jolla, CA (US); Alberto RICO ALVARINO, San Diego, CA (US); Umesh PHUYAL, San Diego, CA (US); Haris ZISIMOPOULOS, London (GB); Kazuki TAKEDA, Minato-ku (JP); Ozcan OZTURK, San Diego, CA (US)

(21) Appl. No.: 18/044,779

(22) PCT Filed: Oct. 8, 2021
(86) PCT No.: PCT/US2021/054291

§ 371 Date: Mar. 9, 2023

(30) Foreign Application Priority Data
Oct. 21, 2020 (GR) 20200100634

(51) Int. Cl. H04W 72/12; H04W 72/30; H04W 72/232

(52) U.S. Cl. CPC H04W 72/30; H04W 72/12; H04W 72/232

(57) ABSTRACT

Methods, systems, and devices for wireless communications are described. Some wireless communications systems may support multicast communications, which may relate to a multicast service (for example, a multimedia broadcast multicast service (MBMS)). A communications device such as a UE may transition from an inactive or idle state to a connected state to receive multicast services and provide feedback to the network. A wireless network may implement different techniques to trigger the UE to transition from the idle or inactive state into the RRC connected state to receive multicast services. For example, the UE may receive a trigger message that indicates that the one or more multicast services are available for use by the UE, and the UE may determine whether to transition to an RRC connected state to receive the multicast services based on the trigger message.

### CROSS REFERENCE

The present Application is a 371 national stage filing of International PCT Application No. PCT/US2021/054291 by KADIRI et al., entitled “MULTICAST/BROADCAST SERVICE ALERT,” filed Oct. 8, 2021; and claims priority to Greece Provisional Patent Application No. 2020/0100634 by KADIRI et al., entitled “MULTICAST/BROADCAST SERVICE ALERT,” filed Oct. 21, 2020, each of which is assigned to the assignee hereof, and each of which is expressly incorporated by reference in its entirety herein.

### FIELD OF TECHNOLOGY

The following relates to wireless communications, including multicast/broadcast service alert.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications networks may support multicast communications which may relate to a multicast service (for example, a multimedia broadcast multicast service (MBMS)). Conventional techniques notifying devices of such multicast communications, however, may be deficient.

### SUMMARY

The described techniques relate to improved methods, systems, devices, and apparatuses that support multicast/broadcast service alert. Generally, the described techniques provide support for multicast communications, which may relate to a multicast service (for example, a multimedia broadcast multicast service (MBMS)). In some examples, a communications device such as a user equipment (UE) may receive multicast services while operating in a suspended state such as a radio resource control (RRC) inactive state or a sleep state such as an RRC idle state. A UE that is operating in accordance with an RRC inactive or idle state, however, may not be able to provide feedback (e.g., hybrid automatic repeat request (HARQ) feedback) for a multicast service. Instead, the UE may transition to an RRC connected state to receive the multicast services and to provide feedback.

The wireless communications network may implement different techniques to trigger the UE to transition from an idle or inactive state into an RRC connected state to receive multicast services. For example, a base station may transmit a trigger message that indicates that the one or more multicast services are available for use by the UE, and the UE may determine whether to transition to an RRC connected state to receive the multicast services based on the trigger message. In some examples, the trigger message may be one or more paging messages, a physical downlink control channel (PDCCH) short message, or a service change indication sent via a multicast broadcast control channel (MCCH).

A method for wireless communications at a UE is described. The method may include identifying that the UE is operating in accordance with a first state, wherein the first state is either an RRC-inactive state or an RRC-idle state, receiving, from a base station, a trigger message that indicates that one or more multicast services are available for use by the UE while the UE is in a connected state, and determining whether to transition from the first state to the connected state to receive the one or more multicast services based at least in part on the trigger message.

An apparatus for wireless communications at a UE is described. The apparatus may include a processor, memory in electronic communication with the processor, and instructions stored in the memory. The instructions may be executable by the processor to cause the apparatus to identify that the UE is operating in accordance with a first state, wherein the first state is either an RRC-inactive state or an RRC-idle state, receive, from a base station, a trigger message that indicates that one or more multicast services are available for use by the UE while the UE is in a connected state, and determine whether to transition from the first state to the connected state to receive the one or more multicast services based at least in part on the trigger message.

Another apparatus for wireless communications at a UE is described. The apparatus may include means for identifying that the UE is operating in accordance with a first state, wherein the first state is either an RRC-inactive state or an RRC-idle state, means for receiving, from a base station, a trigger message that indicates that one or more multicast services are available for use by the UE while the UE is in a connected state, and means for determining whether to transition from the first state to the connected state to receive the one or more multicast services based at least in part on the trigger message.

A non-transitory computer-readable medium storing code for wireless communications at a UE is described. The code may include instructions executable by a processor to identify that the UE is operating in accordance with a first state, wherein the first state is either an RRC-inactive state or an RRC-idle state, receive, from a base station, a trigger message that indicates that one or more multicast services are available for use by the UE while the UE is in a connected state, and determine whether to transition from the first state to the connected state to receive the one or more multicast services based at least in part on the trigger message.

Some examples of the method, apparatuses, and non-transitory computer-readable medium described herein may further include operations, features, means, or instructions for receiving, in downlink control information, scheduling information that indicates a plurality of occasions for receiving the trigger message in a physical downlink shared channel, wherein the trigger message comprises an RRC paging message indicating the one or more multicast services.

Some examples of the method, apparatuses, and non-transitory computer-readable medium described herein may further include operations, features, means, or instructions for receiving the RRC paging message in accordance with the scheduling information, identifying a first field in the RRC paging message that indicates a multicast group paging identity associated with the one or more multicast services, and transitioning to the connected state to receive the one or more multicast services based at least in part on the multicast group paging identity.

In some examples of the method, apparatuses, and non-transitory computer-readable medium described herein, the first field comprises a paging record type field comprising a UE specific paging record, a multicast group specific paging record, or both.

In some examples of the method, apparatuses, and non-transitory computer-readable medium described herein, the multicast group paging identity comprises a group-radio network temporary identifier, a temporary mobile group identity, a multicast-broadcast session identifier, or any combination thereof.

Some examples of the method, apparatuses, and non-transitory computer-readable medium described herein may further include operations, features, means, or instructions for identifying, in the RRC paging message, a service type indication associated with receiving the one or more multicast services based at least in part on the multicast group paging identity.

Some examples of the method, apparatuses, and non-transitory computer-readable medium described herein may further include operations, features, means, or instructions for receiving the RRC paging message in accordance with the scheduling information, identifying a paging identifier in the RRC paging message, wherein the paging identifier comprises a paging record and a multicast session identifier associated with the UE, and transitioning to the connected state to receive the one or more multicast services based at least in part on the paging identifier.

Some examples of the method, apparatuses, and non-transitory computer-readable medium described herein may further include operations, features, means, or instructions for determining that the scheduling information may be scheduling the one or more multicast services based at least in part on a value of a one-bit indicator received in the downlink control information.

Some examples of the method, apparatuses, and non-transitory computer-readable medium described herein may further include operations, features, means, or instructions for receiving, in downlink control information, an indication that the trigger message may be included with the downlink control information in a physical downlink control channel, wherein the trigger message comprises a short message that indicates the one or more multicast services.

Some examples of the method, apparatuses, and non-transitory computer-readable medium described herein may further include operations, features, means, or instructions for identifying a plurality of reserved bits associated with the short message, determining a value of one or more bits of the plurality of reserved bits, wherein the value of the one or more bits indicates the one or more multicast services, and transitioning to the connected state to receive the one or more multicast services based at least in part on the value of the one or more bits.

Some examples of the method, apparatuses, and non-transitory computer-readable medium described herein may further include operations, features, means, or instructions for determining the one or more bits comprises a single reserved bit associated with the short message and transitioning to the connected state to receive the one or more multicast services based at least in part on a value of the single reserved bit.

Some examples of the method, apparatuses, and non-transitory computer-readable medium described herein may further include operations, features, means, or instructions for determining the one or more bits comprises a set of reserved bits associated with the short message, identifying a multicast service or a group of multicast services of the one or more multicast services based at least in part on a value of the set of reserved bits, and transitioning to the connected state to receive the multicast service or the group of multicast services based at least in part on the value of the set of reserved bits.

In some examples of the method, apparatuses, and non-transitory computer-readable medium described herein, identifying a multicast service or a group of multicast services may include operations, features, means, or instructions for receiving an RRC message indicating a mapping between the value of the set of reserved bits and a plurality of different multicast services or groups of multicast services.

Some examples of the method, apparatuses, and non-transitory computer-readable medium described herein may further include operations, features, means, or instructions for receiving the trigger message in a system information block (SIB), the SIB including a multicast-broadcast control channel configuration and determining whether to receive the one or more multicast services on the multicast-broadcast control channel in accordance with the first state or the connected state based at least in part on the multicast-broadcast control channel configuration.

Some examples of the method, apparatuses, and non-transitory computer-readable medium described herein may further include operations, features, means, or instructions for receiving a multicast-broadcast control channel change notification during a multicast-broadcast control channel modification period, wherein the multicast-broadcast control channel change notification indicates content change information for the multicast-broadcast control channel and monitoring the multicast-broadcast control channel for the content change information based at least in part on the multicast-broadcast control channel change notification.

In some examples of the method, apparatuses, and non-transitory computer-readable medium described herein, the multicast-broadcast control channel change notification comprises a downlink control information message scrambled with a multicast-broadcast control channel radio network temporary identifier, a medium access control message, a SIB, or any combination thereof.

In some examples of the method, apparatuses, and non-transitory computer-readable medium described herein, the multicast-broadcast control channel change notification further comprises a single bit or a group of bits in the downlink control information message, and each bit of the group of bits indicates a different type of multicast-broadcast control channel change.

In some examples of the method, apparatuses, and non-transitory computer-readable medium described herein, the multicast-broadcast control channel change indicated by the group of bits comprises a start of a new multicast-broadcast session, an addition of a multicast-broadcast service, an indication of a multicast-broadcast service update, or any combination thereof.

In some examples of the method, apparatuses, and non-transitory computer-readable medium described herein, the content change information indicates a start of a multicast-broadcast session, a change in multicast-broadcast control channel content or service, or both.

Some examples of the method, apparatuses, and non-transitory computer-readable medium described herein may further include operations, features, means, or instructions for identifying a change to a multicast service or a broadcast service based at least in part on the multicast-broadcast control channel change notification and determining whether to transition to the connected state or to remain in the first state to receive the change based at least in part on the multicast service or the broadcast service.

Some examples of the method, apparatuses, and non-transitory computer-readable medium described herein may further include operations, features, means, or instructions for monitoring a group-radio network temporary identifier or paging radio network temporary identifier associated with the trigger message and identifying the trigger message associated with the one or more multicast services based at least in part on the monitoring.

A method for wireless communications at a base station is described. The method may include identifying that a UE is operating in accordance with a first state, wherein the first state is either an RRC-inactive state or an RRC-idle state and transmitting a trigger message to the UE that indicates that one or more multicast services are available for use by the UE while the UE is in a connected state.

An apparatus for wireless communications at a base station is described. The apparatus may include a processor, memory in electronic communication with the processor, and instructions stored in the memory. The instructions may be executable by the processor to cause the apparatus to identify that a UE is operating in accordance with a first state, wherein the first state is either an RRC-inactive state or an RRC-idle state and transmit a trigger message to the UE that indicates that one or more multicast services are available for use by the UE while the UE is in a connected state.

Another apparatus for wireless communications at a base station is described. The apparatus may include means for identifying that a UE is operating in accordance with a first state, wherein the first state is either an RRC-inactive state or an RRC-idle state and means for transmitting a trigger message to the UE that indicates that one or more multicast services are available for use by the UE while the UE is in a connected state.

A non-transitory computer-readable medium storing code for wireless communications at a base station is described. The code may include instructions executable by a processor to identify that a UE is operating in accordance with a first state, wherein the first state is either an RRC-inactive state or an RRC-idle state and transmit a trigger message to the UE that indicates that one or more multicast services are available for use by the UE while the UE is in a connected state.

Some examples of the method, apparatuses, and non-transitory computer-readable medium described herein may further include operations, features, means, or instructions for determining scheduling information for a plurality of occasions for transmitting the trigger message to the UE in a physical downlink control channel, wherein the trigger message comprises an RRC paging message indicating the one or more multicast services and transmitting, to the UE, downlink control information indicating the scheduling information.

Some examples of the method, apparatuses, and non-transitory computer-readable medium described herein may further include operations, features, means, or instructions for transmitting the RRC paging message in accordance with the scheduling information, the RRC paging message including a first field in that indicates a multicast group paging identity associated with the one or more multicast services.

In some examples of the method, apparatuses, and non-transitory computer-readable medium described herein, the first field comprises a paging record type field comprising a UE specific paging record, a multicast group specific paging record, or both.

In some examples of the method, apparatuses, and non-transitory computer-readable medium described herein, the multicast group paging identity comprises a group radio network temporary identifier, a temporary mobile group identity, a multicast-broadcast session identifier, or any combination thereof.

Some examples of the method, apparatuses, and non-transitory computer-readable medium described herein may further include operations, features, means, or instructions for transmitting, in the RRC paging message, a service type indication associated with the one or more multicast services based at least in part on the multicast group paging identity.

Some examples of the method, apparatuses, and non-transitory computer-readable medium described herein may further include operations, features, means, or instructions for transmitting the RRC paging message in accordance with the scheduling information, the RRC paging message comprising a paging identifier that includes a paging record and a multicast session identifier associated with the UE.

Some examples of the method, apparatuses, and non-transitory computer-readable medium described herein may further include operations, features, means, or instructions for transmitting a one-bit indicator in the downlink control information, wherein the one-bit indicator comprises a notification that the one or more multicast services may be scheduled.

Some examples of the method, apparatuses, and non-transitory computer-readable medium described herein may further include operations, features, means, or instructions for transmitting an indication that the trigger message may be included with the downlink control information in a physical downlink control channel, wherein the trigger message comprises a short message that indicates the one or more multicast services.

Some examples of the method, apparatuses, and non-transitory computer-readable medium described herein may further include operations, features, means, or instructions for configuring a plurality of reserved bits in the short message, wherein a value of one or more bits of the plurality of reserved bits indicates the one or more multicast services available to the UE.

Some examples of the method, apparatuses, and non-transitory computer-readable medium described herein may further include operations, features, means, or instructions for configuring a single reserved bit in the short message, wherein a value of the single reserved bit indicates a multicast service available to the UE.

Some examples of the method, apparatuses, and non-transitory computer-readable medium described herein may further include operations, features, means, or instructions for configuring a set of reserved bits in the short message, wherein the set of reserved bits indicates a multicast service or a group of multicast services based at least in part on a value of the set of reserved bits.

Some examples of the method, apparatuses, and non-transitory computer-readable medium described herein may further include operations, features, means, or instructions for transmitting an RRC message that indicates a mapping between the value of the set of reserved bits and a plurality of different multicast services or groups of multicast services.

Some examples of the method, apparatuses, and non-transitory computer-readable medium described herein may further include operations, features, means, or instructions for transmitting the trigger message in a SIB, the SIB including a multicast-broadcast control channel configuration.

Some examples of the method, apparatuses, and non-transitory computer-readable medium described herein may further include operations, features, means, or instructions for transmitting a multicast-broadcast control channel change notification during a multicast-broadcast control channel modification period, wherein the multicast-broadcast control channel change notification indicates content change information for the multicast-broadcast control channel.

In some examples of the method, apparatuses, and non-transitory computer-readable medium described herein, the multicast-broadcast control channel change notification comprises a downlink control information message scrambled with a multicast-broadcast control channel radio network temporary identifier, a medium access control message, a SIB, or any combination thereof.

In some examples of the method, apparatuses, and non-transitory computer-readable medium described herein, the multicast-broadcast control channel change notification further comprises a single bit or a group of bits in the downlink control information message, and each bit of the group of bits indicates a different type of multicast-broadcast control channel change.

In some examples of the method, apparatuses, and non-transitory computer-readable medium described herein, the multicast-broadcast control channel change indicated by the group of bits comprises a start of a new multicast-broadcast session, an addition of a multicast-broadcast service, an indication of a multicast-broadcast service update, or any combination thereof.

In some examples of the method, apparatuses, and non-transitory computer-readable medium described herein, the content change information indicates a start of a multicast-broadcast session, a change in multicast-broadcast control channel content or service, or both.

Some examples of the method, apparatuses, and non-transitory computer-readable medium described herein may further include operations, features, means, or instructions for identifying a change to a multicast service or a broadcast service and transmitting, to the UE, an indication of the change in the multicast-broadcast control channel change notification.

Some examples of the method, apparatuses, and non-transitory computer-readable medium described herein may further include operations, features, means, or instructions for transmitting, to the UE, a group radio network temporary identifier or paging radio network temporary identifier associated with identifying the trigger message.

### BRIEF DESCRIPTION OF THE DRAWINGS

FIG. 1 illustrates an example of a wireless communications system that supports multicast/broadcast service alert in accordance with aspects of the present disclosure.

FIG. 2 illustrates an example of a wireless communications system that supports multicast/broadcast service alert in accordance with aspects of the present disclosure.

FIG. 3 illustrates an example of a process flow that supports multicast/broadcast service alert in accordance with aspects of the present disclosure.

FIGS. 4 and 5 show block diagrams of devices that support multicast/broadcast service alert in accordance with aspects of the present disclosure.

FIG. 6 shows a block diagram of a communications manager that supports multicast/broadcast service alert in accordance with aspects of the present disclosure.

FIG. 7 shows a diagram of a system including a device that supports multicast/broadcast service alert in accordance with aspects of the present disclosure.

FIGS. 8 and 9 show block diagrams of devices that support multicast/broadcast service alert in accordance with aspects of the present disclosure.

FIG. 10 shows a block diagram of a communications manager that supports multicast/broadcast service alert in accordance with aspects of the present disclosure.

FIG. 11 shows a diagram of a system including a device that supports multicast/broadcast service alert in accordance with aspects of the present disclosure.

FIGS. 12 through 18 show flowcharts illustrating methods that support multicast/broadcast service alert in accordance with aspects of the present disclosure.

### DETAILED DESCRIPTION

Some wireless communications systems such as fifth generation (5G) new radio (NR) communications systems may support multicast communications, which may relate to a multicast service (for example, a multimedia broadcast multicast service (MBMS)). A multicast service may include a point-to-multipoint communication scheme in which information (for example, in the form of packets or multicast data) is transmitted simultaneously from a single source (e.g., a base station) to multiple destinations (e.g., multiple user equipments (UEs)). Additionally or alternatively, a multicast service may refer to a distribution of information among a specific group of communications devices in a multicast group that subscribe to the multicast service. In some cases, multicast services may support high reliability and low latency requirements of the wireless communications system.

In some examples, a communications device such as a UE may receive multicast services while operating in a suspended state such as a radio resource control (RRC) inactive state or a sleep state such as an RRC idle state. A UE that is operating in accordance with an RRC inactive or idle state, however, may not be able to provide feedback (e.g., hybrid automatic repeat request (HARQ) feedback) for a multicast service. Instead, the UE may establish (or re-establish) an RRC connection with the network to receive multicast services and to increase the reliability and quality of the multicast services.

The wireless network may employ a number of different methods to trigger the UE to transition from an idle or inactive state into an RRC connected state to receive the one or more multicast services. In a first example, a base station may transmit RRC paging messages to the UE during a number of shared channel paging occasions or UE specific paging occasions, where each paging message contains a multicast paging record type and a multicast group paging identity which notifies the UE of the multicast services. Based on the paging messages, the UE may enter a connected state to receive the multicast services. In a second example, the base station may indicate the one or more multicast services in a physical downlink control channel (PDCCH) short message transmitted to the UE. The short message may include one or more reserved bits that may indicate the multicast services. In cases that the UE identifies the multicast services in the short message, the UE may enter a connected state to receive the services. In a third example, the UE may communicate with the base station using a multicast broadcast control channel (MCCH) scheduling a multicast traffic channel (MTCH). The UE may receive MCCH change notification which indicates an initiation, change, or termination of the multicast services. The UE may enter the RRC connected state to receive the one or more multicast services based on the MCCH change notification.

Particular aspects of the subject matter described herein may be implemented to realize one or more advantages. The described techniques may support improved communications reliability and quality for multicast services. For example, a UE may transition from an idle or inactive state to a connected state to receive multicast services, and to transmit feedback to the network. In such examples, the network may transmit retransmissions of the multicast services in cases where the UE incorrectly receives the services, which may increase reliability. In addition, the techniques may reduce traffic and signaling overhead for the network, which may transmit multicast or broadcast communications to multiple UEs at once. As such, supported techniques may include improved network operations and may promote increased communications efficiency, among other benefits.

Aspects of the disclosure are initially described in the context of wireless communications systems, for example, wireless communications systems supporting multicast-broadcast communications. Aspects of the disclosure are further illustrated by and described with reference to apparatus diagrams, system diagrams, a process flow, and flowcharts that relate to multicast/broadcast service alert.

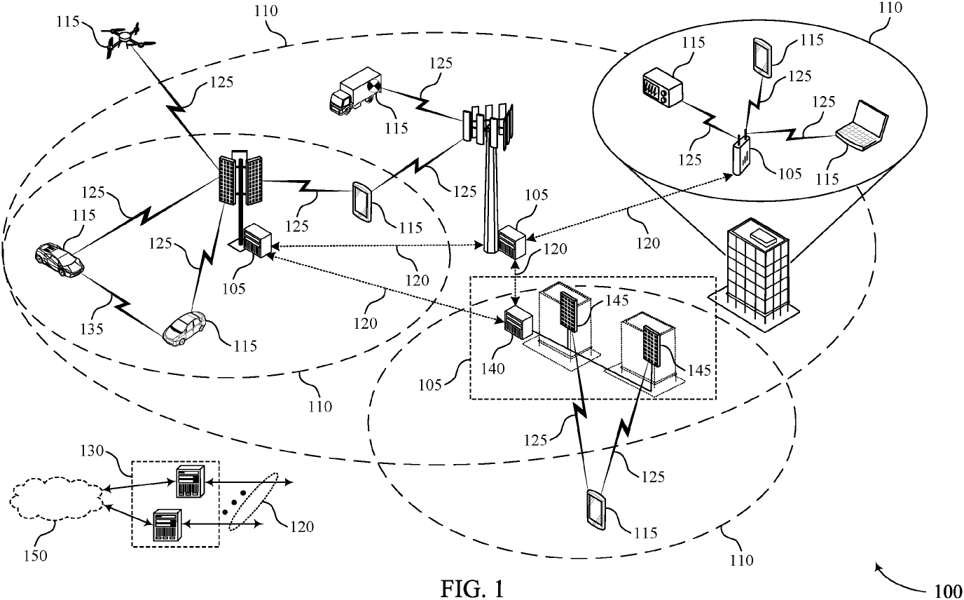

FIG. 1 illustrates an example of a wireless communications system 100 that supports multicast/broadcast service alert in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ = 1/(Δfₘₐₓ . N_{f} ) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. HARQ feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Some wireless communications systems may support multicast communications, which may relate to a multicast service (for example, an MBMS). A multicast service may include a point-to-multipoint communication scheme in which information (for example, in the form of packets or multicast data) is transmitted simultaneously from a single source (e.g., a base station 105) to multiple destinations (e.g., multiple user equipments (UEs) 115). Additionally, a multicast service may refer to a distribution of information among a specific group of communication devices in a multicast group that are subscribed to the multicast service.

In some examples, a communications device such as a UE 115 may receive multicast services while operating in a suspended state such as an RRC inactive state or a sleep state such as an RRC idle state. A UE 115 that operates in accordance with an RRC inactive or idle state, however, may not be able to provide feedback (e.g., HARQ feedback) for a multicast service. Instead, the UE 115 may transition to an RRC connected state to receive the multicast services.

The wireless communications network 100 may employ a number of different methods to trigger the UE 115 to transition from an idle or inactive state into an RRC connected state. In a first example, a base station 105 may transmit RRC paging messages to the UE 115 during a number of shared channel paging occasions, where each paging message contains a multicast paging record type and a multicast group paging identity which notifies the UE 115 of the multicast services. In another example, the base station 105 may indicate the one or more multicast services in a physical downlink control channel (PDCCH) short message transmitted to the UE 115. The short message may include one or more reserved bits that may be used to indicate the multicast services. In yet another example, the UE 115 may communicate with the base station 105 using a MCCH. The UE may receive MCCH change notification which indicates an initiation, change, or termination of the multicast services.

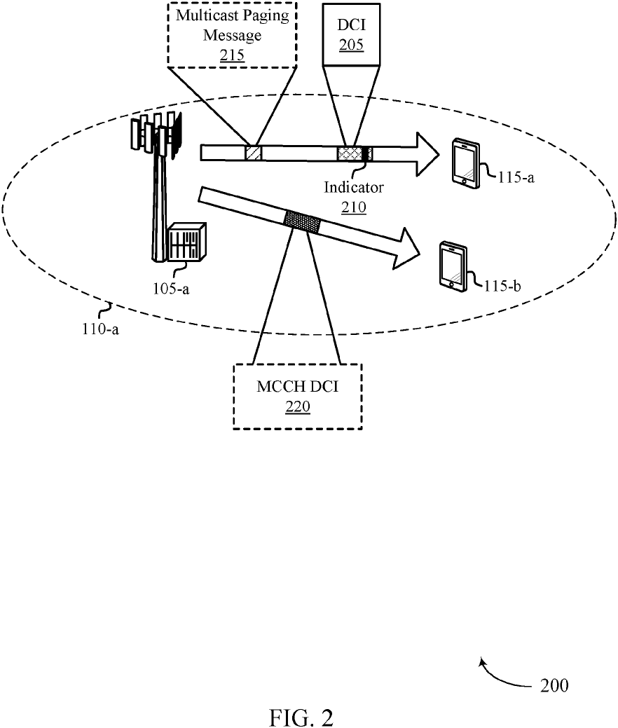

FIG. 2 illustrates an example of a wireless communications system 200 that supports multicast/broadcast service alert in accordance with aspects of the present disclosure. In some examples, wireless communications system 200 may implement aspects of wireless communication system 100. For example, the wireless communications system may include a base station 105-a and multicast UEs 115-a and 115-b, which may be examples of corresponding devices described with respect to FIG. 1. Although FIG. 2 shows communications between a base station 105-a and two multicast UEs 115, these processes may occur between any number of network devices.

Some wireless communications systems, such as 5G NR communications systems, may support multicast communications, which may relate to a multicast service (for example, an MBMS). A multicast service may include a point-to-multipoint communication scheme in which information (e.g., in the form of packets) is transmitted simultaneously from a single source (e.g., a base station 105-a) to multiple destinations (e.g., multiple communication devices). Additionally, a multicast service may refer to a distribution of information among a specific group of communication devices (e.g., a group of UEs 115-a and 115-b) that are subscribed to the multicast service. In some cases, multicast services may support high reliability and low latency requirements of the wireless communications system.

In some examples, a communications device such as a UE (e.g., UE 115-a or UE 115-b) may receive multicast services while operating in a suspended state such as an RRC inactive state (e.g., RRC_INACTIVE) or another low power operating state such as an RRC idle state (e.g., RRC _IDLE). A UE that is operating in accordance with an RRC inactive or idle state, however, may not be able to provide feedback (e.g., HARQ feedback) for a multicast service, for example, device-specific (e.g., UE-specific) feedback, as well as group-specific feedback for the multicast service. In some cases, the idle or inactive UE may resume a connection with the network by transitioning to an RRC connected state (e.g., RRC_CONNECTED) in order to provide layer 1 (L1) or layer 2 (L2) type feedback for the MBMS services received from the base station 105-a, and in some cases the base station 105-a may re-transmit multicast data to the UEs based on receiving the feedback. Thus, to increase the reliability and quality of service for some multicast services, UEs 115-a and 115-b may enter into RRC connected state to receive the multicast services.

In some examples, the UE 115-a and the UE 115-b may be part of a multicast group in which the UEs 115 may receive multicast services and parameters as part of one or more multicast transmissions from the base station 105-a. To notify the UEs 115-a and 115-b of the multicast service configurations and other configuration parameters (e.g., point-to-point (PTP) and point-to-multipoint (PTM)) parameters, the base station 105-a may transmit dedicated RRC signaling to the UEs 115-a and 115-b, and the UEs may receive the RRC signaling while in an RRC connected state. In some other cases, the base station 105-a may transmit both dedicated RRC signaling and a system information block (SIB) along with one or more multicast-broadcast control channel (MCCH) transmissions indicating the multicast services.

Before a UE 115 receives multicast services, the UE 115 may establish a NAS session (e.g., based on a NAS session management procedure or an internet group management protocol (IGMP) procedure). During a multicast session setup procedure, a core network session management function (SMF) of the wireless communications network 200 may provide a multicast session configuration to UEs 115. For example, the base station 105-a may transmit the multicast session configuration to the UEs 115, which may include a number of parameters including a multicast quality of service indicator, a multicast-broadcast (MBS) session ID, and other multicast configuration information. In some examples, the MBS session ID format include a MBS session ID type and an MBS session ID value (e.g., [MBS session ID type] [MBS session ID value]), where MBS session ID type indicates either a temporary mobile group identify (TMGI), a native transport scalar, or an IP multicast address. The core network may use NAS session management signaling or RAN paging to notify the UEs 115 of the MBS session ID. Based on the MBS session ID, the UEs 115 and the network may identify the multicast-broadcast session

To notify the UEs 115 of any multicast service change (e.g., a multicast configuration change, an initiation or termination of a multicast service, a NAS session change, etc.) using control plane signaling, the network may employ different paging techniques based on a connection status of the UEs 115. For example, the network may implement core network paging to notify the multicast UEs of a NAS session or multicast configuration change in an RRC idle state, and the network may implement RAN paging for notifying UEs in an RRC inactive state. In some other examples, a network may use access stratum (AS) signaling to notify configuration changes for a multicast-broadcast radio bearer (MRB). In some cases, the network may notify the UEs to enter an RRC connected state upon receiving an MRB notification. In some examples, the MBS notification may be an MBS-P-RNTI or a UE specific RAN paging message, which prompts the UEs 115 to transition into the RRC connected state. In some other cases, the UEs 115 may support multicast communications in an idle or inactive state, the UEs 115 may receive an updated MRB configuration in an MCCH.

In some other examples, the UEs 115 may receive multicast services and multicast data while the user plane is unavailable. For example, in cases where an MBS session resource is released by the network (e.g., user plane resources between user plane function and base station 105-a, and over-the-air radio bearer resources may be unavailable). In such cases, the base station 105-a may transmit an MBS notification (e.g., a paging message, short message, or MCCH change notification) to the UEs 115 to notify the UEs of the multicast services or of a transmission of the multicast data. In some cases, the MBS notification may prompt the UEs 115 to enter an RRC connected state to receive the data via an MRB. In some other cases (e.g., if UEs 115 are configured for monitoring the MCCH), the UEs may receive the MRB configuration via the MCCH or by using on demand MCCH.

In some examples, the UEs 115 may receive multicast data when MBS session resource is available in RAN in the RRC connected state, (e.g., user plane resources between user plane function and base station 105-a, and over-the-air radio bearer resources may be available). In some cases, UEs 115 may support receiving the multicast resources while in an idle or inactive state, where UEs 115 may or may not enter into an RRC connected state to receive multicast data.

In some examples, the base station 105-a may identify one or more multicast services for UEs 115 while one or both UEs are operating in accordance with an RRC idle or RRC inactive mode. The base station 105-a may employ a number of different methods to trigger the UEs 115 to transition from an idle or inactive state to an RRC connected state to receive the one or more multicast services. For example, the base station 105-a may employ paging-based methods, where an indication of the one or more multicast services are included in paging messages transmitted to the UEs 115. In some other examples, the base station may indicate the one or more multicast services in a physical downlink control channel (PDCCH) short message transmitted to the UEs 115. In yet other examples, the base station 105-a may communicate with the UEs 115 using communications on the MCCH, and the base station 105-a may notify the UEs 115 of changes in a multicast traffic channel (MTCH) or a MTCH configuration which may be used to transmit the one or more multicast services.

In a first example, the base station 105-a may notify the UEs 115-a and 115-b of the one or more multicast services using RRC paging techniques. For example, the UE 115-a may receive DCI 205 in a PDCCH transmission from the base station 105-a. In some examples, the DCI 205 may be a DCI format 1_0, and may be scrambled with a paging radio network temporary identifier (P-RNTI). In addition, the DCI 205 may include a short message indicator which may include an indication of the contents of the DCI 205. In some examples, indicator 210 may be a bitfield having potential values 00, 01, 10, and 11. For a value of 00, the indicator may indicate a reserved DCI 205. For a value of 01, the indicator may indicate that the DCI 205 contains scheduling information for the location to receive paging messages transmitted from the base station 105-a in one or more paging occasions. For a value of 10, the indicator may indicate that the DCI 205 contains a PDCCH short message. For a value of 11, the indicator may indicate that the DCI 205 contains both scheduling information for paging occasions along with the PDCCH short message.

In examples where the network implements multicast paging techniques to notify the UE 115-a of a multicast service, the base station may configure the indicator 210 to have a bit field value of 01 in the DCI 205. The value of the indicator 210 may notify the UE 115-a of one or more paging occasions that the UE 115-a may monitor during RRC idle or RRC inactive state operation. The DCI 205 may further indicate that the network may use paging techniques for triggering the UE 115-a to transition to a connected state to receive multicast services.

To trigger the UE 115-a to enter an RRC connected state, the base station 105-a may include a multicast paging record type field in the RRC multicast paging message 215 which contains a multicast group paging identity. In some examples, the paging record type field may be different from the paging record type field already included in the multicast paging message 215. Based on the multicast paging record type and the multicast paging identity, the UE 115-a may determine that the base station 105-a has multicast services to transmit and may transition to an RRC connected state to receive the multicast services. In some examples, the multicast group paging identity may be a group-RNTI (G-RNTI), a TMGI, an MBS session ID, or any other identification or trigger message. In some other examples, the base station 105-a may modify the current paging record type to include a multicast group paging identity. In such examples, a single multicast paging message may include both UE specific paging records (e.g., paging records configured for UE 115-a) and multicast group specific paging records (e.g., paging records configured for the multicast group including both UE 115-a and UE 115-b). In addition, the multicast paging message 215 may indicate a multicast service type indication that notifies the UE 115-a of the multicast services.

In some other implementations, the base station 105-a may use UE-specific paging to notify the UE 115-a of the multicast services. For example, using UE-specific paging techniques, the base station 105-a may transmit a UE-specific paging ID to each UE individually (e.g., the base station 105-a may transmit a different paging IDs to UE 115-a and 115-b, respectively). The UE specific paging ID may include a UE specific Short-Temporary Mobile Subscriber Identity (S-TMSI) or an RNTI such as a full I-RNTI. The UE-specific paging messages may further include the paging record and the multicast session identifier (e.g., a G-RNTI, TMGI, MBS Session ID etc.). The base station 105-a may transmit the UE-specific paging message in a UE-specific paging occasion, and the UE-specific paging message may notify the UE 115-a of the multicast transmissions to other UEs in the multicast group.

Additionally or alternatively, the base station 105-a may format the DCI 205 (e.g., DCI format 1_0) to include a single bit indication which may notify the UE 115-a of the multicast services. For example, the DCI may indicate a bit value of 1 to indicate multicast services, and a bit value of 0 may indicate unicast or other services.

In some other examples, the base station 105-a may configure the indicator 210 to have a bit field value of 10 or 11 in the DCI 205. The value of the indicator 210 may notify the UE 115-a that the DCI contains a short message or both the short message and scheduling information for paging messages for the UE 115-a to monitor during RRC idle or RRC inactive state operation. The DCI 205 may further indicate that the network may use a PDCCH short message for triggering the UE 115-a to transition to a connected state to receive multicast services. CRC bits of DCI 205 may be scrambled by a multicast P-RNTI (which may be based on the G-RNTI used for multicast transmissions). UEs in the multicast paging group (e.g., UEs 115-a and 115-b) that are configured to receive a multicast service identified by the G-RNTI may monitor for a DCI scrambled by the G-RNTI or P-RNTI during multicast paging occasions.

The PDCCH short message may include a number of reserved bits (e.g., 8 reserved bits). Bits 1 through 3 of the short message may indicate a number of system parameters, indications for emergency signaling, and paging message monitoring information. Bits 4 through 8 may be unallocated. In some examples, the base station 105-a may select a single bit from bits 4 through 8 of the short message to use for transmitting the multicast service alert. For example, the base station 105-a may select bit 4 of the short message for indicating the multicast service alert. In such examples, bit 4 may be set to 1 in cases where multicast services are to be provided by the base station 105-a, and based on receiving the bit indication, the UE 115-a may enter an RRC connected state to receive the multicast service.

In some other examples, the base station 105-a may allocate a set of the reserved short message bits (e.g., bits 4 through 6) to identify the multicast service (as identified by the G-RNTI, TMGI, MBS session ID, etc.). In some cases, the base station 105-a may use the set of bits to notify the UE 115-a of a number of different multicast services. For example, bit set value of 101 may indicate a first multicast-broadcast service (e.g., MBS service X), a bit set value of 110 may indicate a second multicast-broadcast service (e.g., MBS service Y). In some other cases, the base station 105-a may use the set of bits to notify the UE 115-a of a number of different sets or groups of multicast services. For example, bit set value of 110 may indicate a first group of multicast-broadcast services (e.g., MBS group 1 services), a bit set value of 111 may indicate a second group of multicast-broadcast services (e.g., MBS group 2 services). The base station 105-a may further transmit dedicated RRC signaling which may indicate a mapping between multicast service IDs or multicast service grouping IDs and associated short message bits so that the UE 115-a may identify associated multicast services associated with the bit values given in the short message.

In some other cases, the base station 105-a may notify multicast UEs 115 of the one or more multicast services through one or more MCCH transmissions. The base station 105-a may transmit a SIB which contains information for receiving the MCCH, which contains scheduling information for receiving the MTCH and for receiving the one or more multicast services, in addition to an MCCH configuration. The MCCH and the MTCH may be transmitted on the PDSCH (e.g., scheduled by PDCCH), however, the MCCH may be scrambled with the MCCH-RNTI, while the MTCH may be scrambled with G-RNTI.

In some examples, the MCCH can be used to carry the multicast-broadcast service configuration and a connected mode C-DRX configuration for the one or more multicast-broadcast services. The MTCH may be mapped to a downlink shared channel and may carry the multicast-broadcast data traffic scheduled by the MCCH. Various multicast channel operations may be received and performed by a UE that is in an idle or inactive state, or a connected state.

The network may periodically update MCCH content during a MCCH modification period based on the start of a multicast broadcast session or other MCCH configuration changes. The base station 105-a may notify multicast UEs (e.g., such as UE 115-b) to read updated MCCH information by including a MCCH change notification within the MCCH modification period. Within the MCCH modification period, the UE 115-b may receive a PDCCH DCI 220 associated with the MCCH, and the PDCCH DCI 220 may be scrambled with a MCCH-N-RNTI to indicate MCCH content changes. Additionally or alternatively, the base station 105-a may configure a bit indicator in the DCI 220 to indicate the MCCH content change, of the base station 105-a may transmit a MAC-CE to the UE 115-b to inform the MCCH content change.

The PDCCH DCI 220 (or a MAC-CE) may include multiple bits to indicate different types of MCCH content changes (e.g., an addition of a multicast service, or an indication that a multicast service is starting or is removed). To differentiate between a multicast content change and a broadcast content change, different MCCH-N-RNTIs or different MAC-CE (identified by different LCIDs) may be used, or a bit indication in the PDCCH DCI may indicate the different multicast and broadcast services.

Upon receiving the MCCH indicating the multicast services, the UE 115-b may transition from an idle or inactive state into an RRC connected state in order to receive the services on the MTCH. In cases where the MCCH indicates broadcast services, the UE 115-b may remain in an idle or inactive state to receive the services on the MTCH.

In some other cases, the MCCH content change may be indicated by a single bit in the MCCH DCI 220, or by a group of configured bits. In such cases, the group of bits may indicate a number of different MCCH changes. For example, a first bit may indicate the start of a new multicast session. A second bit may indicate a new multicast service that is added to a list of multicast services. A third bit may indicate that the multicast service info has been updated. A fourth bit may indicate one or more new broadcast services added to a list of broadcast services. A fifth bit may indicate the start of a broadcast service session. A sixth bit may indicate broadcast service configuration changes. In some cases, the bits may indicate different multicast-broadcast parameters.

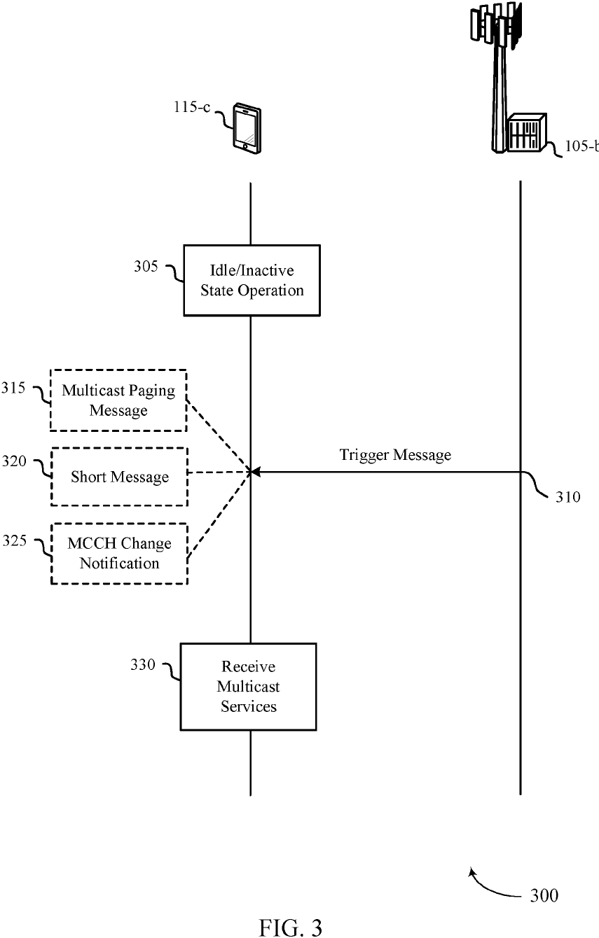

FIG. 3 illustrates an example of a process flow 300 that supports multicast/broadcast service alert in accordance with aspects of the present disclosure. In some examples, process flow 300 may implement aspects of wireless communication system 100. The process flow 300 includes UE 115-c and base station 105-b (e.g., which may be examples of the corresponding devices described with reference to FIGS. 1 and 2). Alternative examples of the following may be implemented, where some steps are performed in a different order than described or are not performed at all. In some cases, steps may include additional features not mentioned below, or further steps may be added. In addition, while process flow 300 shows processes between base station 105-b and a single UE 115-c, it should be understood that these processes may occur between any number of network devices.

At 305, the UE 115-c operate in accordance with a first connection state (e.g., an RRC inactive state or an RRC idle state). In some examples, the first state may be a low power or sleep state which may conserve battery power of the UE 115-c.

At 310, the UE 115-c may format a DCI for transmitting control information to the UE 115-c. The DCI may indicate a trigger message that notifies the UE 115-c to transition from an RRC idle or inactive state to an RRC connected state in order to receive one or more multicast-broadcast services. In some examples, the UE 115-c may monitor a G-RNTI or a P-RNTI associated with the trigger message and may identify the trigger message associated with the one or more multicast services based on the monitoring.

In one example, the UE 115-c may receive a DCI at that indicates one or more paging occasions for receiving trigger messages from the base station 105-b, where the trigger message is an RRC paging message 315 indicating the one or more multicast services. In some examples, the UE 115-c may identify a first field in the RRC paging message 315 that indicates a multicast group paging ID associated with the one or more multicast services. Based on the multicast group paging ID (e.g., which may be a G-RNTI, TMGI, a multicast-broadcast session ID, etc.), the UE 115-c may transition to the connected state at 330 to receive the one or more multicast services. In some other examples, the first field in the RRC paging message 315 may be a paging record type field which includes a UE-specific paging record, a multicast group specific paging record, or both.

In some examples, the RRC paging message 315 may explicitly indicate a service type as multicast, such that the UE 115-c may transition to the RRC connected state at 330 to receive the services. In some other cases, the RRC paging message 315 may include a paging identifier in the that includes a paging record and a multicast session ID that is specific to the UE 115-c or to the multicast group of the UE 115-c. Based on the multicast session ID and the paging record, the UE 115-c may transition to the RRC connected state at 330 in order to receive the multicast services. In some cases, the UE 115-c may determine that the scheduling information contained in the DCI is scheduling the one or more multicast services based on a one bit indicator in the DCI (e.g., a bit value of 1 indicates multicast services, a bit value of 0 indicates unicast or other services).

In another example, the UE 115-c may receive a DCI that indicates that the trigger message is a PDCCH short message 320 contained in the DCI, where the short message indicates the one or more multicast services. The UE 115-c may identify a set of reserved bits associated with the short message 320 (e.g., 8 reserved bits), and may determine that one or more bits of the set of reserved bits indicates the one or more multicast services. Based on the one or more bits in the short message 320, the UE 115-c may transition to an RRC connected state at 330 to receive the one or more multicast services. In some cases, the one or more bits may be a single reserved bit (e.g., bit 4) or a set of reserved bits (e.g., bits 4-6) of the short message 320 which indicates a multicast service or a group of multicast services. In some cases, the base station 105-b may provide a mapping between the value of the one or more reserved bits and a number of multicast services such that the UE 115-c may identify a multicast service or group of multicast services associated with various different bit values of the short message 320.

In another example, the UE 115-c may receive the trigger message in a SIB which indicates a multicast-broadcast control channel configuration. The UE 115-c may determine whether to receive the one or more multicast services on the MCCH while operating in a low power state or a connected state based at least in part on the MCCH configuration. In some cases, the UE 115-c may receive a MCCH change notification 325 during an MCCH modification period. For example, the MCCH change notification 325 may be a DCI scrambled with a MCCH RNTI, a MAC message, or a SIB. In some other examples, the MCCH change notification 325 may be a single bit or a group of bits in the DCI message such that each bit of the group of bits indicates a different type of MCCH content change (e.g., a start of a new multicast-broadcast session, an addition of a multicast-broadcast service, an indication of a multicast-broadcast service update, a change in MCCH content or service, etc.).

In some examples, the MCCH change notification indicates content change information for the MCCH, and the UE 115-c may monitor the MCCH for content change information in accordance with the MCCH change notification 325. Based on the MCCH change notification 325, the UE 115-c may determine whether to transition to the RRC connected state at 330 to receive the one or more multicast services. For example, the UE 115-c may transition to the RRC connected state at 330 to receive a multicast service but may remain in an idle or inactive state to receive a broadcast message.

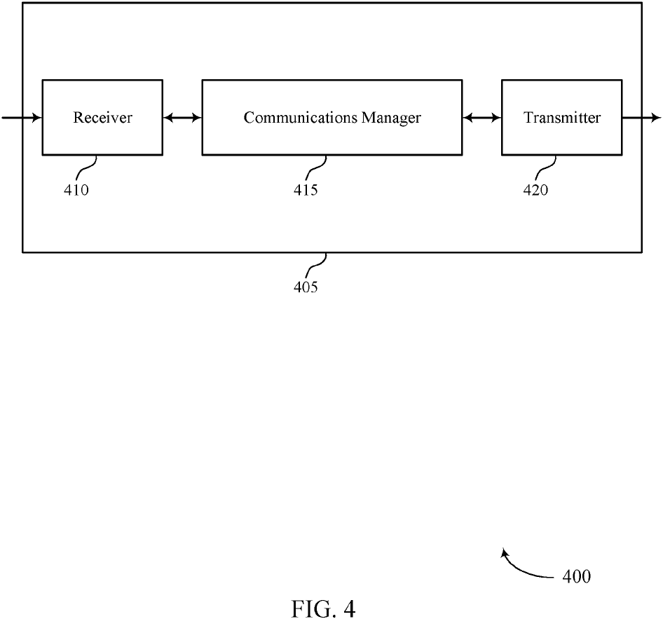

FIG. 4 shows a block diagram 400 of a device 405 that supports multicast/broadcast service alert in accordance with aspects of the present disclosure. The device 405 may be an example of aspects of a UE 115 as described herein. The device 405 may include a receiver 410, a communications manager 415, and a transmitter 420. The device 405 may also include a processor. Each of these components may be in communication with one another (e.g., via one or more buses).

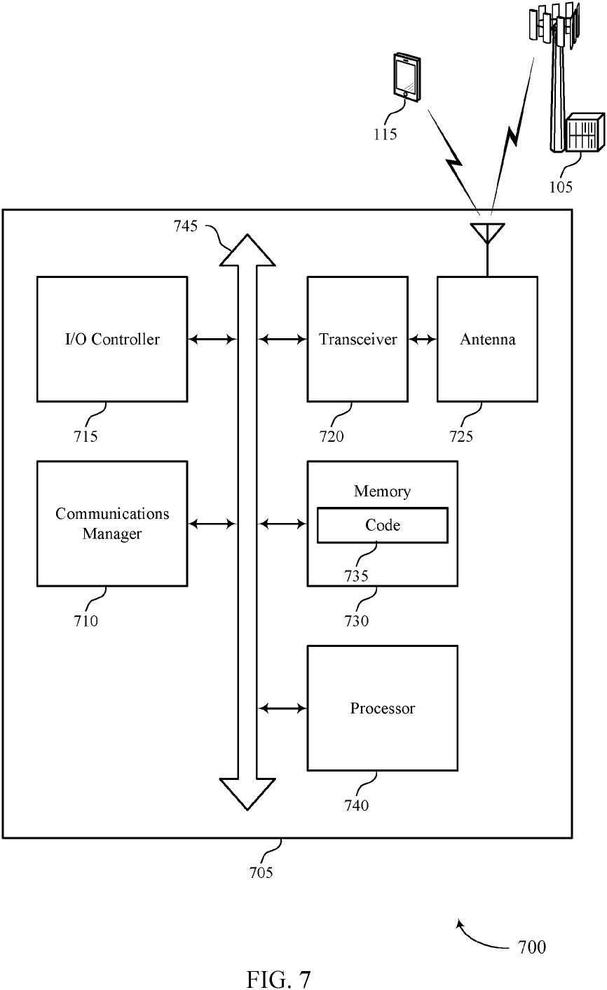

The receiver 410 may receive information such as packets, user data, or control information associated with various information channels (e.g., control channels, data channels, and information related to multicast/broadcast service alert, etc.). Information may be passed on to other components of the device 405. The receiver 410 may be an example of aspects of the transceiver 720 described with reference to FIG. 7. The receiver 410 may utilize a single antenna or a set of antennas.

The communications manager 415 may identify that the UE is operating in accordance with a first state, where the first state is either an RRC-inactive state or a RRC-idle state, receive, from a base station, a trigger message that indicates that one or more multicast services are available for use by the UE while the UE is in a connected state, and determine whether to transition from the first state to the connected state to receive the one or more multicast services based on the trigger message. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

In some examples, communications manager 415 may be implemented as an integrated circuit or chipset for a mobile device modem, and the receiver 410 and transmitter 420 may be implemented as analog components (e.g., amplifiers, filters, and antennas) coupled with the mobile device modem to enable wireless transmission and reception.

The communications manager 415 as described herein may be implemented to realize one or more potential advantages. At least one implementation may enable communications manager 415 to effectively receive one or more triggering messages from a network device, which may notify the device 405 of available multicast-broadcast services. At least one implementation may enable the communications manager 415 to determine whether to transition to an RRC connected state to receive the available multicast-broadcast services.

Based on implementing the techniques as described herein, one or more processors of the device 405 (e.g., processor(s) controlling or incorporated with one or more of receiver 410, communications manager 415, and transmitter 420) may effectively improve reliability and quality of service of the multicast-broadcast services. In some other examples, the techniques described may reduce system overhead by supporting multicast transmissions to multiple network devices at once.

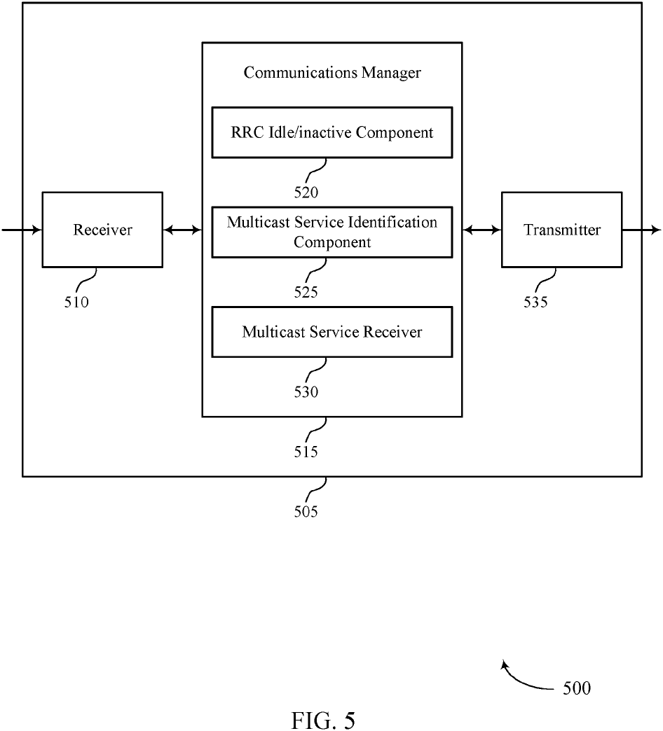

FIG. 5 shows a block diagram 500 of a device 505 that supports multicast/broadcast service alert in accordance with aspects of the present disclosure. The device 505 may be an example of aspects of a device 405, or a UE 115 as described herein. The device 505 may include a receiver 510, a communications manager 515, and a transmitter 535. The device 505 may also include a processor. Each of these components may be in communication with one another (e.g., via one or more buses).

The receiver 510 may receive information such as packets, user data, or control information associated with various information channels (e.g., control channels, data channels, and information related to multicast/broadcast service alert, etc.). Information may be passed on to other components of the device 505. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include an RRC idle/inactive component 520, a multicast service identification component 525, and a multicast service receiver 530. The communications manager 515 may be an example of aspects of the communications manager 710 described herein.

The RRC idle/inactive component 520 may identify that the UE is operating in accordance with a first state, where the first state is either a RRC-inactive state or a RRC-idle state. The multicast service identification component 525 may receive, from a base station, a trigger message that indicates that one or more multicast services are available for use by the UE while the UE is in a connected state.

The multicast service receiver 530 may determine whether to transition from the first state to the connected state to receive the one or more multicast services based on the trigger message. The transmitter 535 may transmit signals generated by other components of the device 505. In some examples, the transmitter 535 may be collocated with a receiver 510 in a transceiver module. For example, the transmitter 535 may be an example of aspects of the transceiver 720 described with reference to FIG. 7. The transmitter 535 may utilize a single antenna or a set of antennas.

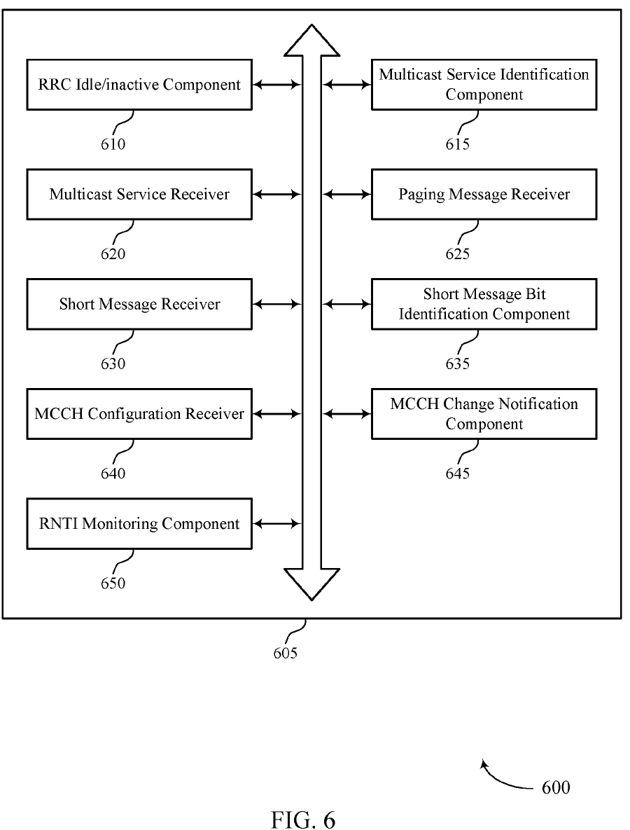

FIG. 6 shows a block diagram 600 of a communications manager 605 that supports multicast/broadcast service alert in accordance with aspects of the present disclosure. The communications manager 605 may be an example of aspects of a communications manager 415, a communications manager 515, or a communications manager 710 described herein. The communications manager 605 may include an RRC idle/inactive component 610, a multicast service identification component 615, a multicast service receiver 620, a paging message receiver 625, a short message receiver 630, a short message bit identification component 635, a MCCH configuration receiver 640, a MCCH change notification component 645, and a RNTI monitoring component 650. Each of these modules may communicate, directly or indirectly, with one another (e.g., via one or more buses).

The RRC idle/inactive component 610 may identify that the UE is operating in accordance with a first state, where the first state is either a RRC-inactive state or a RRC-idle state.

The multicast service identification component 615 may receive, from a base station, a trigger message that indicates that one or more multicast services are available for use by the UE while the UE is in a connected state.

The multicast service receiver 620 may determine whether to transition from the first state to the connected state to receive the one or more multicast services based on the trigger message. In some examples, the multicast service receiver 620 may determine whether to transition to the connected state or to remain in the first state to receive the change based on the multicast service or the broadcast service.

The paging message receiver 625 may receive, in downlink control information, scheduling information that indicates a set of occasions for receiving the trigger message in a physical downlink shared channel, where the trigger message includes a RRC paging message indicating the one or more multicast services. In some examples, the multicast service identification component 615 may determine that the scheduling information is scheduling the one or more multicast services based on a value of a one-bit indicator received in the downlink control information.

In some examples, the paging message receiver 625 may receive the RRC paging message in accordance with the scheduling information. In some examples, the paging message receiver 625 may identify a first field in the RRC paging message that indicates a multicast group paging identity associated with the one or more multicast services. In some examples, the paging message receiver 625 may identify, in the RRC paging message, a service type indication associated with receiving the one or more multicast services based on the multicast group paging identity. In some examples, the multicast service receiver 620 may transition to the connected state to receive the one or more multicast services based on the multicast group paging identity.

In some examples, identifying a paging identifier in the RRC paging message, where the paging identifier includes a paging record and a multicast session identifier associated with the UE. In some cases, the first field includes a paging record type field including a UE specific paging record, a multicast group specific paging record, or both. In some examples, the multicast service receiver 620 may transition to the connected state to receive the one or more multicast services based on the paging identifier.

The short message receiver 630 may receive, in downlink control information, an indication that the trigger message is included with the downlink control information in a physical downlink control channel, where the trigger message includes a short message that indicates the one or more multicast services.

The short message bit identification component 635 may identify a set of reserved bits associated with the short message. In some examples, the multicast service identification component 615 may receive a RRC message indicating a mapping between the value of the set of reserved bits and a set of different multicast services or groups of multicast services. In some examples, the multicast service receiver 620 may transition to the connected state to receive the one or more multicast services based on a value of the single reserved bit. In some examples, the multicast service receiver 620 may transition to the connected state to receive the multicast service or the group of multicast services based on the value of the set of reserved bits. In some examples, the short message bit identification component 635 may determine a value of one or more bits of the set of reserved bits, where the value of the one or more bits indicates the one or more multicast services. In some examples, the one or more bits includes a single reserved bit associated with the short message. In some examples, the one or more bits includes a set of reserved bits associated with the short message. In some examples, the short message bit identification component 635 may identify a multicast service or a group of multicast services of the one or more multicast services based on a value of the set of reserved bits. In some examples, the multicast service receiver 620 may transition to the connected state to receive the one or more multicast services based on the value of the one or more bits.

The MCCH configuration receiver 640 may receive the trigger message in a SIB, the SIB including a multicast-broadcast control channel configuration. The MCCH change notification component 645 may receive a multicast-broadcast control channel change notification during a multicast-broadcast control channel modification period, where the multicast-broadcast control channel change notification indicates content change information for the multicast-broadcast control channel.

In some examples, the MCCH change notification component 645 may monitor the multicast-broadcast control channel for the content change information based on the multicast-broadcast control channel change notification. In some examples, the MCCH change notification component 645 may identify a change to a multicast service or a broadcast service based on the multicast-broadcast control channel change notification. In some examples, the multicast service receiver 620 may determine whether to receive the one or more multicast services on the MCCH in accordance with the first state or the connected state based on the MCCH configuration.

In some cases, the multicast-broadcast control channel change notification includes a downlink control information message scrambled with a multicast-broadcast control channel radio network temporary identifier, a medium access control message, a SIB, or any combination thereof.

In some cases, the multicast-broadcast control channel change notification further includes a single bit or a group of bits in the downlink control information message, where each bit of the group of bits indicates a different type of multicast-broadcast control channel change. In some cases, the multicast-broadcast control channel change indicated by the group of bits includes a start of a new multicast-broadcast session, an addition of a multicast-broadcast service, an indication of a multicast-broadcast service update, or any combination thereof. In some cases, the content change information indicates a start of a multicast-broadcast session, a change in multicast-broadcast control channel content or service, or both.

The RNTI monitoring component 650 may monitor a group-radio network temporary identifier or paging radio network temporary identifier associated with the trigger message. In some cases, the multicast group paging identity includes a G-RNTI, a temporary mobile group identity, a multicast-broadcast session identifier, or any combination thereof. In some examples, the RNTI monitoring component 650 may identify the trigger message associated with the one or more multicast services based on the monitoring.

FIG. 7 shows a diagram of a system 700 including a device 705 that supports multicast/broadcast service alert in accordance with aspects of the present disclosure. The device 705 may be an example of or include the components of device 405, device 505, or a UE 115 as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may identify that the UE is operating in accordance with a first state, where the first state is either a RRC-inactive state or a RRC-idle state, receive, from a base station, a trigger message that indicates that one or more multicast services are available for use by the UE while the UE is in a connected state, and determine whether to transition from the first state to the connected state to receive the one or more multicast services based on the trigger message.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting multicast/broadcast service alert).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

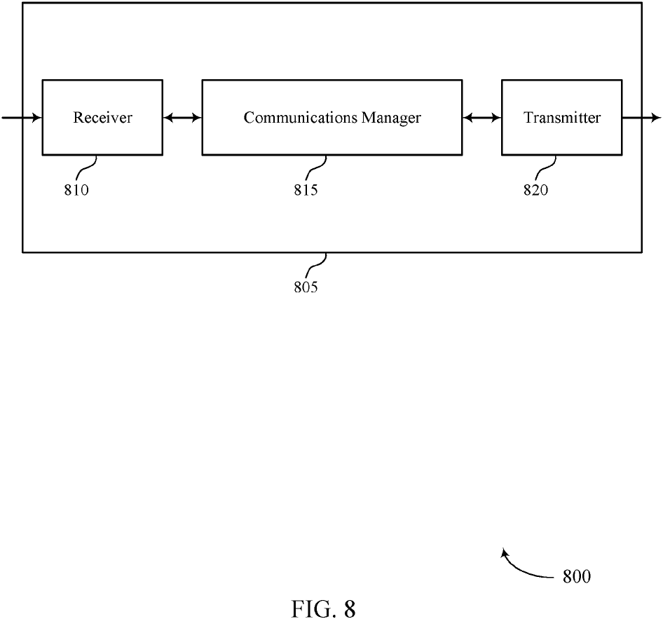

FIG. 8 shows a block diagram 800 of a device 805 that supports multicast/broadcast service alert in accordance with aspects of the present disclosure. The device 805 may be an example of aspects of a base station 105 as described herein. The device 805 may include a receiver 810, a communications manager 815, and a transmitter 820. The device 805 may also include a processor. Each of these components may be in communication with one another (e.g., via one or more buses).

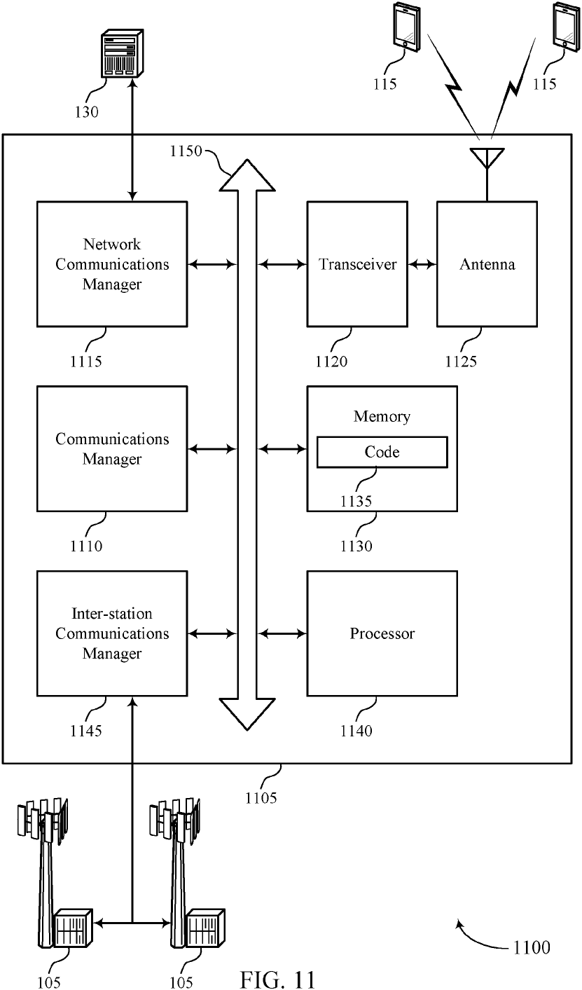

The receiver 810 may receive information such as packets, user data, or control information associated with various information channels (e.g., control channels, data channels, and information related to multicast/broadcast service alert, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may identify that a UE is operating in accordance with a first state, where the first state is either a RRC-inactive state or a RRC-idle state and transmit a trigger message to the UE that indicates that one or more multicast services are available for use by the UE while the UE is in a connected state. The communications manager 815 may be an example of aspects of the communications manager 1110 described herein.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

In some examples, communications manager 815 may be implemented as an integrated circuit or chipset for a mobile device modem, and the receiver 810 and transmitter 820 may be implemented as analog components (e.g., amplifiers, filters, and antennas) coupled with the mobile device modem to enable wireless transmission and reception.

The communications manager 815 as described herein may be implemented to realize one or more potential advantages. At least one implementation may enable communications manager 815 to effectively transmit one or more triggering messages to a device, which may notify the device of available multicast-broadcast services.

Based on implementing the techniques as described herein, one or more processors of the device 805 (e.g., processor(s) controlling or incorporated with one or more of receiver 810, communications manager 815, and transmitter 820) may effectively improve reliability and quality of service of the multicast-broadcast services. In some other examples, the techniques described may reduce system overhead by supporting multicast transmissions to multiple network devices at once.

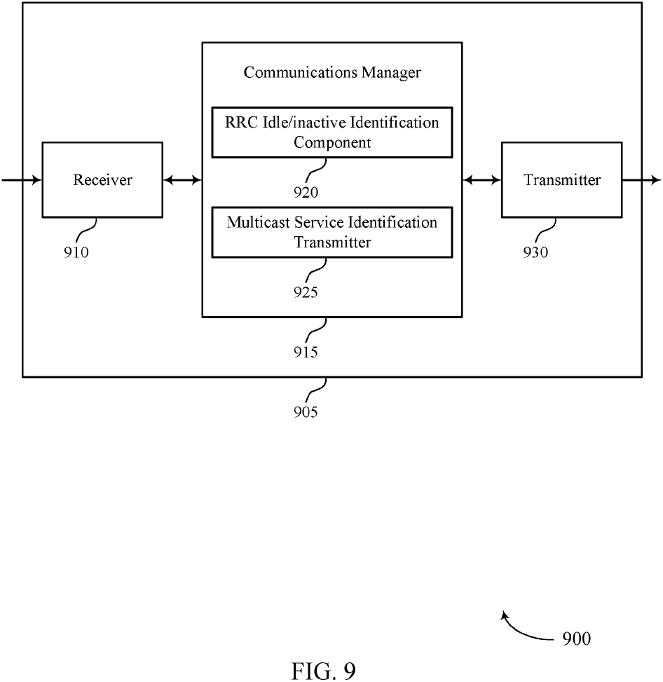

FIG. 9 shows a block diagram 900 of a device 905 that supports multicast/broadcast service alert in accordance with aspects of the present disclosure. The device 905 may be an example of aspects of a device 805, or a base station 105 as described herein. The device 905 may include a receiver 910, a communications manager 915, and a transmitter 930. The device 905 may also include a processor. Each of these components may be in communication with one another (e.g., via one or more buses).

The receiver 910 may receive information such as packets, user data, or control information associated with various information channels (e.g., control channels, data channels, and information related to multicast/broadcast service alert, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include an RRC idle/inactive identification component 920 and a multicast service identification transmitter 925. The communications manager 915 may be an example of aspects of the communications manager 1110 described herein.

The RRC idle/inactive identification component 920 may identify that a UE is operating in accordance with a first state, where the first state is either a RRC-inactive state or a RRC-idle state.

The multicast service identification transmitter 925 may transmit a trigger message to the UE that indicates that one or more multicast services are available for use by the UE while the UE is in a connected state.

The transmitter 930 may transmit signals generated by other components of the device 905. In some examples, the transmitter 930 may be collocated with a receiver 910 in a transceiver module. For example, the transmitter 930 may be an example of aspects of the transceiver 1120 described with reference to FIG. 11. The transmitter 930 may utilize a single antenna or a set of antennas.

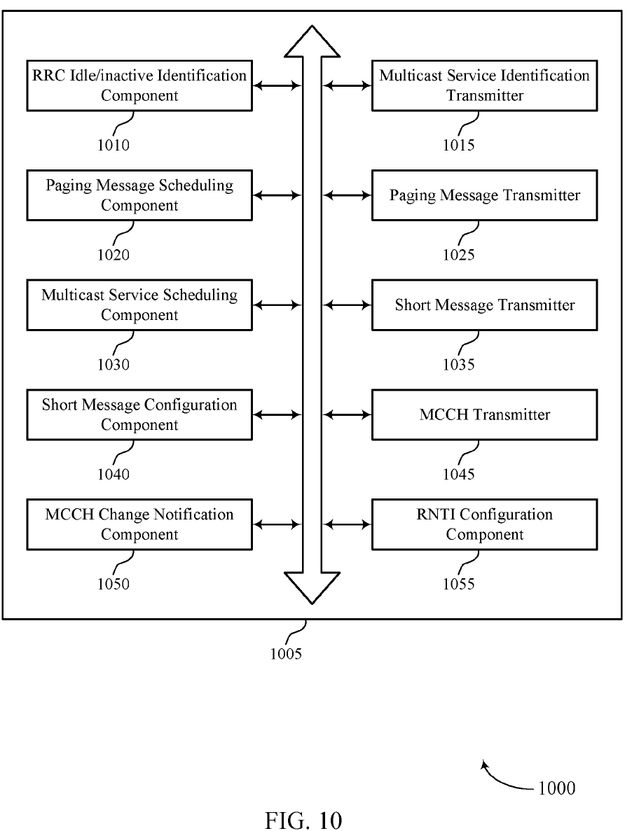

FIG. 10 shows a block diagram 1000 of a communications manager 1005 that supports multicast/broadcast service alert in accordance with aspects of the present disclosure. The communications manager 1005 may be an example of aspects of a communications manager 815, a communications manager 915, or a communications manager 1110 described herein. The communications manager 1005 may include an RRC idle/inactive identification component 1010, a multicast service identification transmitter 1015, a paging message scheduling component 1020, a paging message transmitter 1025, a multicast service scheduling component 1030, a short message transmitter 1035, a short message configuration component 1040, a MCCH transmitter 1045, a MCCH change notification component 1050, and a RNTI configuration component 1055. Each of these modules may communicate, directly or indirectly, with one another (e.g., via one or more buses).

The RRC idle/inactive identification component 1010 may identify that a UE is operating in accordance with a first state, where the first state is either a RRC-inactive state or a RRC-idle state.

The multicast service identification transmitter 1015 may transmit a trigger message to the UE that indicates that one or more multicast services are available for use by the UE while the UE is in a connected state.

The paging message scheduling component 1020 may determine scheduling information for a set of occasions for transmitting the trigger message to the UE in a physical downlink control channel, where the trigger message includes a RRC paging message indicating the one or more multicast services.

In some examples, the paging message scheduling component 1020 may transmit, to the UE, downlink control information indicating the scheduling information. The paging message transmitter 1025 may transmit the RRC paging message in accordance with the scheduling information, the RRC paging message including a first field in that indicates a multicast group paging identity associated with the one or more multicast services.

In some examples, the paging message transmitter 1025 may transmit, in the RRC paging message, a service type indication associated with the one or more multicast services based on the multicast group paging identity. In some examples, the paging message transmitter 1025 may transmit the RRC paging message in accordance with the scheduling information, the RRC paging message including a paging identifier that includes a paging record and a multicast session identifier associated with the UE.

In some cases, the first field includes a paging record type field including a UE specific paging record, a multicast group specific paging record, or both.

In some cases, the multicast group paging identity includes a group radio network temporary identifier, a temporary mobile group identity, a multicast-broadcast session identifier, or any combination thereof. The multicast service scheduling component 1030 may transmit a one-bit indicator in the downlink control information, where the one-bit indicator includes a notification that the one or more multicast services are scheduled.

The short message transmitter 1035 may transmit an indication that the trigger message is included with the downlink control information in a physical downlink control channel, where the trigger message includes a short message that indicates the one or more multicast services. In some examples, the short message transmitter 1035 may transmit a RRC message that indicates a mapping between the value of the set of reserved bits and a set of different multicast services or groups of multicast services.

The short message configuration component 1040 may configure a set of reserved bits in the short message, where a value of one or more bits of the set of reserved bits indicates the one or more multicast services available to the UE. In some examples, the short message configuration component 1040 may configure a single reserved bit in the short message, where a value of the single reserved bit indicates a multicast service available to the UE. In some examples, the short message configuration component 1040 may configure a set of reserved bits in the short message, where the set of reserved bits indicates a multicast service or a group of multicast services based on a value of the set of reserved bits.

The MCCH transmitter 1045 may transmit the trigger message in a SIB, the SIB including a multicast-broadcast control channel configuration. The MCCH change notification component 1050 may transmit a multicast-broadcast control channel change notification during a multicast-broadcast control channel modification period, where the multicast-broadcast control channel change notification indicates content change information for the multicast-broadcast control channel. In some examples, the MCCH change notification component 1050 may identify a change to a multicast service or a broadcast service.

In some examples, the MCCH change notification component 1050 may transmit, to the UE, an indication of the change in the multicast-broadcast control channel change notification. In some cases, the multicast-broadcast control channel change notification includes a downlink control information message scrambled with a multicast-broadcast control channel radio network temporary identifier, a medium access control message, a SIB, or any combination thereof. In some cases, the multicast-broadcast control channel change notification further includes a single bit or a group of bits in the downlink control information message, where each bit of the group of bits indicates a different type of multicast-broadcast control channel change.

In some cases, the multicast-broadcast control channel change indicated by the group of bits includes a start of a new multicast-broadcast session, an addition of a multicast-broadcast service, an indication of a multicast-broadcast service update, or any combination thereof. In some cases, the content change information indicates a start of a multicast-broadcast session, a change in multicast-broadcast control channel content or service, or both.

The RNTI configuration component 1055 may transmit, to the UE, a group radio network temporary identifier or paging radio network temporary identifier associated with identifying the trigger message.

FIG. 11 shows a diagram of a system 1100 including a device 1105 that supports multicast/broadcast service alert in accordance with aspects of the present disclosure. The device 1105 may be an example of or include the components of device 805, device 905, or a base station 105 as described herein. The device 1105 may include components for bi-directional voice and data communications including components for transmitting and receiving communications, including a communications manager 1110, a network communications manager 1115, a transceiver 1120, an antenna 1125, memory 1130, a processor 1140, and an inter-station communications manager 1145. These components may be in electronic communication via one or more buses (e.g., bus 1150).

The communications manager 1110 may identify that a UE is operating in accordance with a first state, where the first state is either a RRC-inactive state or a RRC-idle state and transmit a trigger message to the UE that indicates that one or more multicast services are available for use by the UE while the UE is in a connected state.

The network communications manager 1115 may manage communications with the core network (e.g., via one or more wired backhaul links). For example, the network communications manager 1115 may manage the transfer of data communications for client devices, such as one or more UEs 115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM, ROM, or a combination thereof. The memory 1130 may store computer-readable code 1135 including instructions that, when executed by a processor (e.g., the processor 1140) cause the device to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some cases, a memory controller may be integrated into processor 1140. The processor 1140 may be configured to execute computer-readable instructions stored in a memory (e.g., the memory 1130) to cause the device 1105 to perform various functions (e.g., functions or tasks supporting multicast/broadcast service alert).

The inter-station communications manager 1145 may manage communications with other base station 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communication network technology to provide communication between base stations 105.

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

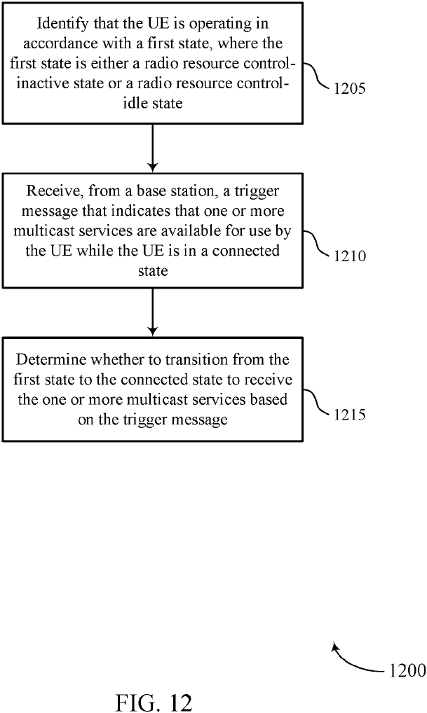

FIG. 12 shows a flowchart illustrating a method 1200 that supports multicast/broadcast service alert in accordance with aspects of the present disclosure. The operations of method 1200 may be implemented by a UE 115 or its components as described herein. For example, the operations of method 1200 may be performed by a communications manager as described with reference to FIGS. 4 through 7. In some examples, a UE may execute a set of instructions to control the functional elements of the UE to perform the functions described below. Additionally, or alternatively, a UE may perform aspects of the functions described below using special-purpose hardware.

At 1205, the UE may identify that the UE is operating in accordance with a first state, where the first state is either a RRC-inactive state or a RRC-idle state. The operations of 1205 may be performed according to the methods described herein. In some examples, aspects of the operations of 1205 may be performed by an RRC idle/inactive component as described with reference to FIGS. 4 through 7.

At 1210, the UE may receive, from a base station, a trigger message that indicates that one or more multicast services are available for use by the UE while the UE is in a connected state. The operations of 1210 may be performed according to the methods described herein. In some examples, aspects of the operations of 1210 may be performed by a multicast service identification component as described with reference to FIGS. 4 through 7.

At 1215, the UE may determine whether to transition from the first state to the connected state to receive the one or more multicast services based on the trigger message. The operations of 1215 may be performed according to the methods described herein. In some examples, aspects of the operations of 1215 may be performed by a multicast service receiver as described with reference to FIGS. 4 through 7.

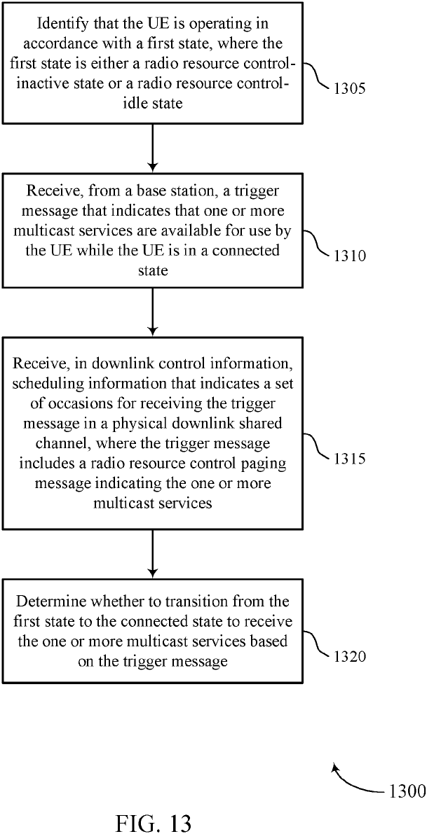

FIG. 13 shows a flowchart illustrating a method 1300 that supports multicast/broadcast service alert in accordance with aspects of the present disclosure. The operations of method 1300 may be implemented by a UE 115 or its components as described herein. For example, the operations of method 1300 may be performed by a communications manager as described with reference to FIGS. 4 through 7. In some examples, a UE may execute a set of instructions to control the functional elements of the UE to perform the functions described below. Additionally, or alternatively, a UE may perform aspects of the functions described below using special-purpose hardware.

At 1305, the UE may identify that the UE is operating in accordance with a first state, where the first state is either a RRC-inactive state or a RRC-idle state. The operations of 1305 may be performed according to the methods described herein. In some examples, aspects of the operations of 1305 may be performed by an RRC idle/inactive component as described with reference to FIGS. 4 through 7.

At 1310, the UE may receive, from a base station, a trigger message that indicates that one or more multicast services are available for use by the UE while the UE is in a connected state. The operations of 1310 may be performed according to the methods described herein. In some examples, aspects of the operations of 1310 may be performed by a multicast service identification component as described with reference to FIGS. 4 through 7.

At 1315, the UE may receive, in downlink control information, scheduling information that indicates a set of occasions for receiving the trigger message in a physical downlink shared channel, where the trigger message includes a RRC paging message indicating the one or more multicast services. The operations of 1315 may be performed according to the methods described herein. In some examples, aspects of the operations of 1315 may be performed by a paging message receiver as described with reference to FIGS. 4 through 7.

At 1320, the UE may determine whether to transition from the first state to the connected state to receive the one or more multicast services based on the trigger message. The operations of 1320 may be performed according to the methods described herein. In some examples, aspects of the operations of 1320 may be performed by a multicast service receiver as described with reference to FIGS. 4 through 7.

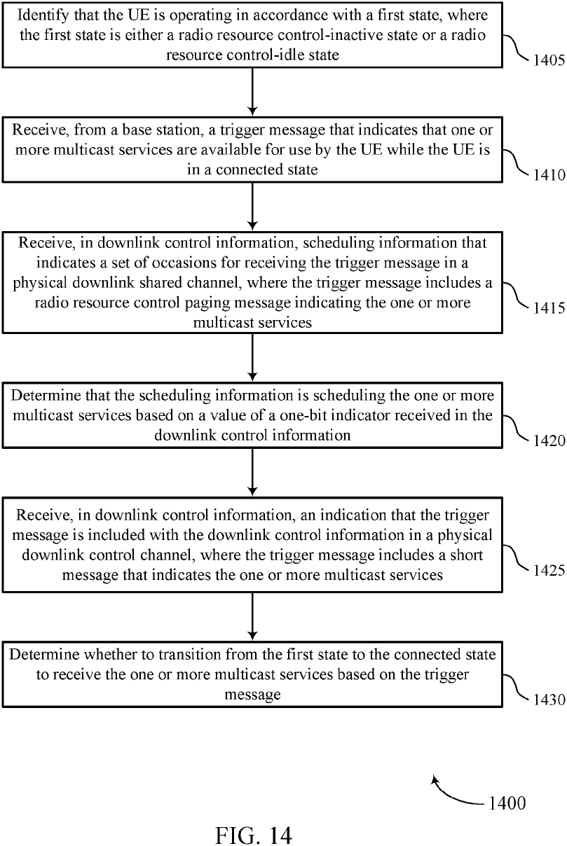

FIG. 14 shows a flowchart illustrating a method 1400 that supports multicast/broadcast service alert in accordance with aspects of the present disclosure. The operations of method 1400 may be implemented by a UE 115 or its components as described herein. For example, the operations of method 1400 may be performed by a communications manager as described with reference to FIGS. 4 through 7. In some examples, a UE may execute a set of instructions to control the functional elements of the UE to perform the functions described below. Additionally, or alternatively, a UE may perform aspects of the functions described below using special-purpose hardware.

At 1405, the UE may identify that the UE is operating in accordance with a first state, where the first state is either a RRC-inactive state or a RRC-idle state. The operations of 1405 may be performed according to the methods described herein. In some examples, aspects of the operations of 1405 may be performed by an RRC idle/inactive component as described with reference to FIGS. 4 through 7.

At 1410, the UE may receive, from a base station, a trigger message that indicates that one or more multicast services are available for use by the UE while the UE is in a connected state. The operations of 1410 may be performed according to the methods described herein. In some examples, aspects of the operations of 1410 may be performed by a multicast service identification component as described with reference to FIGS. 4 through 7.

At 1415, the UE may receive, in downlink control information, scheduling information that indicates a set of occasions for receiving the trigger message in a physical downlink shared channel, where the trigger message includes a RRC paging message indicating the one or more multicast services. The operations of 1415 may be performed according to the methods described herein. In some examples, aspects of the operations of 1415 may be performed by a paging message receiver as described with reference to FIGS. 4 through 7.

At 1420, the UE may determine that the scheduling information is scheduling the one or more multicast services based on a value of a one-bit indicator received in the downlink control information. The operations of 1420 may be performed according to the methods described herein. In some examples, aspects of the operations of 1420 may be performed by a multicast service identification component as described with reference to FIGS. 4 through 7.

At 1425, the UE may receive, in downlink control information, an indication that the trigger message is included with the downlink control information in a physical downlink control channel, where the trigger message includes a short message that indicates the one or more multicast services. The operations of 1425 may be performed according to the methods described herein. In some examples, aspects of the operations of 1425 may be performed by a short message receiver as described with reference to FIGS. 4 through 7.

At 1430, the UE may determine whether to transition from the first state to the connected state to receive the one or more multicast services based on the trigger message. The operations of 1430 may be performed according to the methods described herein. In some examples, aspects of the operations of 1430 may be performed by a multicast service receiver as described with reference to FIGS. 4 through 7.

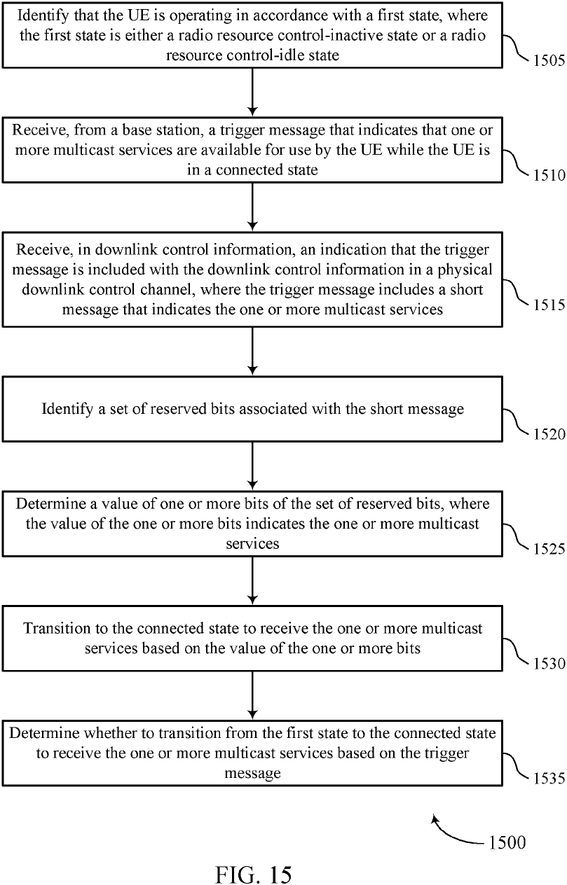

FIG. 15 shows a flowchart illustrating a method 1500 that supports multicast/broadcast service alert in accordance with aspects of the present disclosure. The operations of method 1500 may be implemented by a UE 115 or its components as described herein. For example, the operations of method 1500 may be performed by a communications manager as described with reference to FIGS. 4 through 7. In some examples, a UE may execute a set of instructions to control the functional elements of the UE to perform the functions described below. Additionally, or alternatively, a UE may perform aspects of the functions described below using special-purpose hardware.

At 1505, the UE may identify that the UE is operating in accordance with a first state, where the first state is either a RRC-inactive state or a RRC-idle state. The operations of 1505 may be performed according to the methods described herein. In some examples, aspects of the operations of 1505 may be performed by an RRC idle/inactive component as described with reference to FIGS. 4 through 7.

At 1510, the UE may receive, from a base station, a trigger message that indicates that one or more multicast services are available for use by the UE while the UE is in a connected state. The operations of 1510 may be performed according to the methods described herein. In some examples, aspects of the operations of 1510 may be performed by a multicast service identification component as described with reference to FIGS. 4 through 7.

At 1515, the UE may receive, in downlink control information, an indication that the trigger message is included with the downlink control information in a physical downlink control channel, where the trigger message includes a short message that indicates the one or more multicast services. The operations of 1515 may be performed according to the methods described herein. In some examples, aspects of the operations of 1515 may be performed by a short message receiver as described with reference to FIGS. 4 through 7.

At 1520, the UE may identify a set of reserved bits associated with the short message. The operations of 1520 may be performed according to the methods described herein. In some examples, aspects of the operations of 1520 may be performed by a short message bit identification component as described with reference to FIGS. 4 through 7.

At 1525, the UE may determine a value of one or more bits of the set of reserved bits, where the value of the one or more bits indicates the one or more multicast services. The operations of 1525 may be performed according to the methods described herein. In some examples, aspects of the operations of 1525 may be performed by a short message bit identification component as described with reference to FIGS. 4 through 7.

At 1530, the UE may transition to the connected state to receive the one or more multicast services based on the value of the one or more bits. The operations of 1530 may be performed according to the methods described herein. In some examples, aspects of the operations of 1530 may be performed by a multicast service receiver as described with reference to FIGS. 4 through 7.

At 1535, the UE may determine whether to transition from the first state to the connected state to receive the one or more multicast services based on the trigger message. The operations of 1535 may be performed according to the methods described herein. In some examples, aspects of the operations of 1535 may be performed by a multicast service receiver as described with reference to FIGS. 4 through 7.

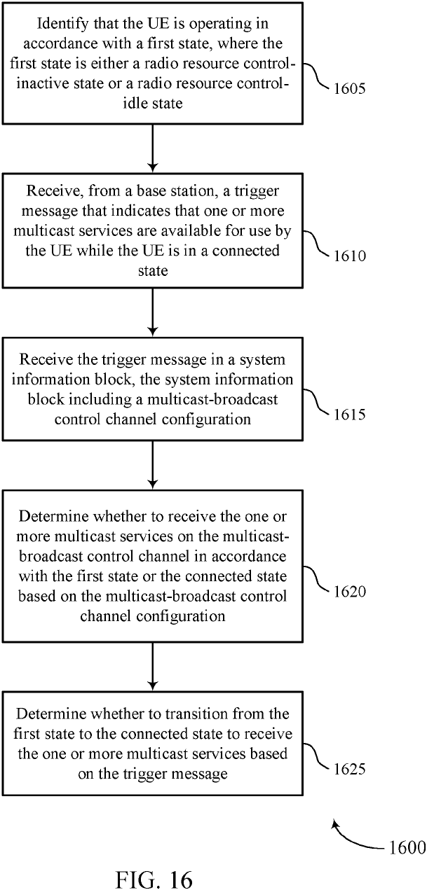

FIG. 16 shows a flowchart illustrating a method 1600 that supports multicast/broadcast service alert in accordance with aspects of the present disclosure. The operations of method 1600 may be implemented by a UE 115 or its components as described herein. For example, the operations of method 1600 may be performed by a communications manager as described with reference to FIGS. 4 through 7. In some examples, a UE may execute a set of instructions to control the functional elements of the UE to perform the functions described below. Additionally, or alternatively, a UE may perform aspects of the functions described below using special-purpose hardware.

At 1605, the UE may identify that the UE is operating in accordance with a first state, where the first state is either a RRC-inactive state or a RRC-idle state. The operations of 1605 may be performed according to the methods described herein. In some examples, aspects of the operations of 1605 may be performed by an RRC idle/inactive component as described with reference to FIGS. 4 through 7.

At 1610, the UE may receive, from a base station, a trigger message that indicates that one or more multicast services are available for use by the UE while the UE is in a connected state. The operations of 1610 may be performed according to the methods described herein. In some examples, aspects of the operations of 1610 may be performed by a multicast service identification component as described with reference to FIGS. 4 through 7.

At 1615, the UE may receive the trigger message in a SIB, the SIB including a multicast-broadcast control channel configuration. The operations of 1615 may be performed according to the methods described herein. In some examples, aspects of the operations of 1615 may be performed by a MCCH configuration receiver as described with reference to FIGS. 4 through 7.

At 1620, the UE may determine whether to receive the one or more multicast services on the multicast-broadcast control channel in accordance with the first state or the connected state based on the multicast-broadcast control channel configuration. The operations of 1620 may be performed according to the methods described herein. In some examples, aspects of the operations of 1620 may be performed by a multicast service receiver as described with reference to FIGS. 4 through 7.

At 1625, the UE may determine whether to transition from the first state to the connected state to receive the one or more multicast services based on the trigger message. The operations of 1625 may be performed according to the methods described herein. In some examples, aspects of the operations of 1625 may be performed by a multicast service receiver as described with reference to FIGS. 4 through 7.

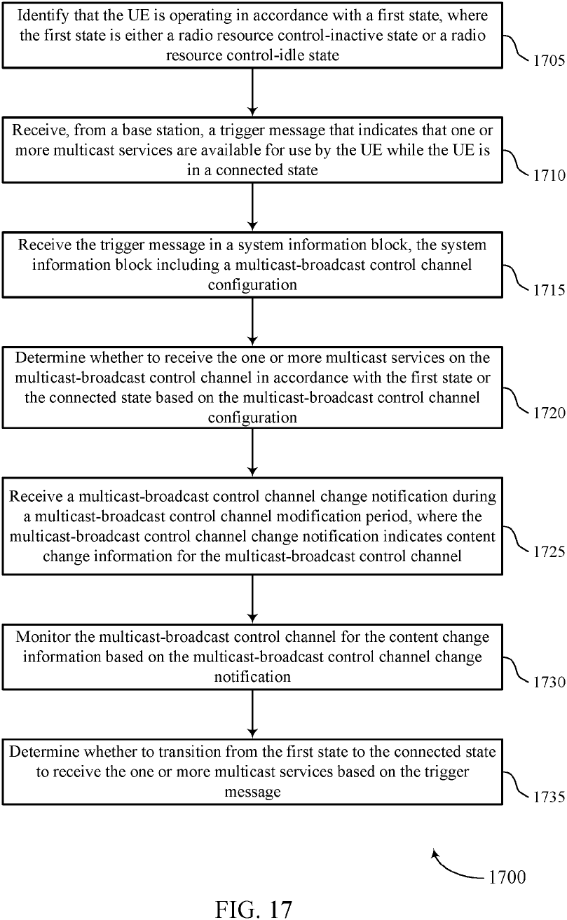

FIG. 17 shows a flowchart illustrating a method 1700 that supports multicast/broadcast service alert in accordance with aspects of the present disclosure. The operations of method 1700 may be implemented by a UE 115 or its components as described herein. For example, the operations of method 1700 may be performed by a communications manager as described with reference to FIGS. 4 through 7. In some examples, a UE may execute a set of instructions to control the functional elements of the UE to perform the functions described below. Additionally, or alternatively, a UE may perform aspects of the functions described below using special-purpose hardware.

At 1705, the UE may identify that the UE is operating in accordance with a first state, where the first state is either a RRC-inactive state or a RRC-idle state. The operations of 1705 may be performed according to the methods described herein. In some examples, aspects of the operations of 1705 may be performed by an RRC idle/inactive component as described with reference to FIGS. 4 through 7.

At 1710, the UE may receive, from a base station, a trigger message that indicates that one or more multicast services are available for use by the UE while the UE is in a connected state. The operations of 1710 may be performed according to the methods described herein. In some examples, aspects of the operations of 1710 may be performed by a multicast service identification component as described with reference to FIGS. 4 through 7.

At 1715, the UE may receive the trigger message in a SIB, the SIB including a multicast-broadcast control channel configuration. The operations of 1715 may be performed according to the methods described herein. In some examples, aspects of the operations of 1715 may be performed by a MCCH configuration receiver as described with reference to FIGS. 4 through 7.

At 1720, the UE may determine whether to receive the one or more multicast services on the multicast-broadcast control channel in accordance with the first state or the connected state based on the multicast-broadcast control channel configuration. The operations of 1720 may be performed according to the methods described herein. In some examples, aspects of the operations of 1720 may be performed by a multicast service receiver as described with reference to FIGS. 4 through 7.

At 1725, the UE may receive a multicast-broadcast control channel change notification during a multicast-broadcast control channel modification period, where the multicast-broadcast control channel change notification indicates content change information for the multicast-broadcast control channel. The operations of 1725 may be performed according to the methods described herein. In some examples, aspects of the operations of 1725 may be performed by a MCCH change notification component as described with reference to FIGS. 4 through 7.

At 1730, the UE may monitor the multicast-broadcast control channel for the content change information based on the multicast-broadcast control channel change notification. The operations of 1730 may be performed according to the methods described herein. In some examples, aspects of the operations of 1730 may be performed by a MCCH change notification component as described with reference to FIGS. 4 through 7.

At 1735, the UE may determine whether to transition from the first state to the connected state to receive the one or more multicast services based on the trigger message. The operations of 1735 may be performed according to the methods described herein. In some examples, aspects of the operations of 1735 may be performed by a multicast service receiver as described with reference to FIGS. 4 through 7.

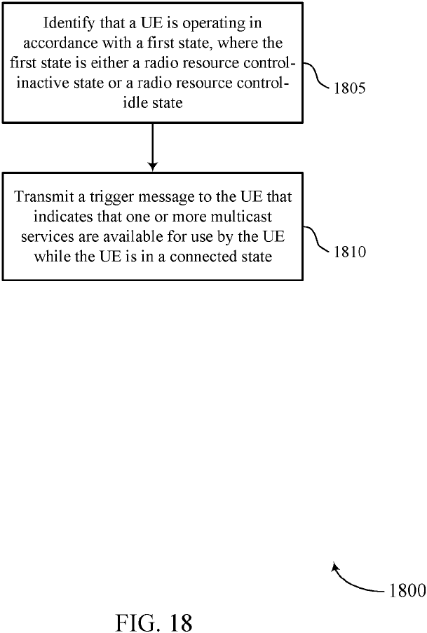

FIG. 18 shows a flowchart illustrating a method 1800 that supports multicast/broadcast service alert in accordance with aspects of the present disclosure. The operations of method 1800 may be implemented by a base station 105 or its components as described herein. For example, the operations of method 1800 may be performed by a communications manager as described with reference to FIGS. 8 through 11. In some examples, a base station may execute a set of instructions to control the functional elements of the base station to perform the functions described below. Additionally, or alternatively, a base station may perform aspects of the functions described below using special-purpose hardware.

At 1805, the base station may identify that a UE is operating in accordance with a first state, where the first state is either a RRC-inactive state or a RRC-idle state. The operations of 1805 may be performed according to the methods described herein. In some examples, aspects of the operations of 1805 may be performed by an RRC idle/inactive identification component as described with reference to FIGS. 8 through 11.

At 1810, the base station may transmit a trigger message to the UE that indicates that one or more multicast services are available for use by the UE while the UE is in a connected state. The operations of 1810 may be performed according to the methods described herein. In some examples, aspects of the operations of 1810 may be performed by a multicast service identification transmitter as described with reference to FIGS. 8 through 11.

The following provides an overview of examples of the present invention:

Example 1: A method for wireless communications at a user equipment (UE), comprising: identifying that the UE is operating in accordance with a first state, wherein the first state is either a RRC-inactive state or a RRC-idle state; receiving, from a base station, a trigger message that indicates that one or more multicast services are available for use by the UE while the UE is in a connected state; and determining whether to transition from the first state to the connected state to receive the one or more multicast services based at least in part on the trigger message.

Example 2: The method of example 1, further comprising: receiving, in downlink control information, scheduling information that indicates a plurality of occasions for receiving the trigger message in a physical downlink shared channel, wherein the trigger message comprises a RRC paging message indicating the one or more multicast services.

Example 3: The method of example 2, further comprising: receiving the RRC paging message in accordance with the scheduling information; identifying a first field in the RRC paging message that indicates a multicast group paging identity associated with the one or more multicast services; and transitioning to the connected state to receive the one or more multicast services based at least in part on the multicast group paging identity.

Example 4: The method of example 3, wherein the first field comprises a paging record type field comprising a UE specific paging record, a multicast group specific paging record, or both.

Example 5: The method of any one of examples 3 through 4, wherein the multicast group paging identity comprises a group-radio network temporary identifier, a temporary mobile group identity, a multicast-broadcast session identifier, or any combination thereof.

Example 6: The method of any one of examples 3 through 5, further comprising: identifying, in the RRC paging message, a service type indication associated with receiving the one or more multicast services based at least in part on the multicast group paging identity.

Example 7: The method of any one of examples 2 through 6, further comprising: receiving the RRC paging message in accordance with the scheduling information; identifying a paging identifier in the RRC paging message, wherein the paging identifier comprises a paging record and a multicast session identifier associated with the UE; and transitioning to the connected state to receive the one or more multicast services based at least in part on the paging identifier.

Example 8: The method of any one of examples 2 through 7, further comprising: determining that the scheduling information is scheduling the one or more multicast services based at least in part on a value of a one-bit indicator received in the downlink control information.

Example 9: The method of any one of examples 1 through 8, further comprising: receiving, in downlink control information, an indication that the trigger message is included with the downlink control information in a physical downlink control channel, wherein the trigger message comprises a short message that indicates the one or more multicast services.

Example 10: The method of example 9, further comprising: identifying a plurality of reserved bits associated with the short message; determining a value of one or more bits of the plurality of reserved bits, wherein the value of the one or more bits indicates the one or more multicast services; and transitioning to the connected state to receive the one or more multicast services based at least in part on the value of the one or more bits.

Example 11: The method of example 10, further comprising: determining the one or more bits comprises a single reserved bit associated with the short message; and transitioning to the connected state to receive the one or more multicast services based at least in part on a value of the single reserved bit.

Example 12: The method of any one of examples 10 through 11, further comprising: determining the one or more bits comprises a set of reserved bits associated with the short message; identifying a multicast service or a group of multicast services of the one or more multicast services based at least in part on a value of the set of reserved bits; and transitioning to the connected state to receive the multicast service or the group of multicast services based at least in part on the value of the set of reserved bits.

Example 13: The method of example 12, wherein identifying a multicast service or a group of multicast services further comprises: receiving a RRC message indicating a mapping between the value of the set of reserved bits and a plurality of different multicast services or groups of multicast services.

Example 14: The method of any one of examples 1 through 13, further comprising: receiving the trigger message in a SIB, the SIB comprising a multicast-broadcast control channel configuration; and determining whether to receive the one or more multicast services on the multicast-broadcast control channel in accordance with the first state or the connected state based at least in part on the multicast-broadcast control channel configuration.

Example 15: The method of example 14, further comprising: receiving a multicast-broadcast control channel change notification during a multicast-broadcast control channel modification period, wherein the multicast-broadcast control channel change notification indicates content change information for the multicast-broadcast control channel; and monitoring the multicast-broadcast control channel for the content change information based at least in part on the multicast-broadcast control channel change notification.

Example 16: The method of example 15, wherein the multicast-broadcast control channel change notification comprises a downlink control information message scrambled with a multicast-broadcast control channel radio network temporary identifier, a medium access control message, a SIB, or any combination thereof.

Example 17: The method of any one of examples 15 through 16, wherein the multicast-broadcast control channel change notification further comprises a single bit or a group of bits in the downlink control information message, each bit of the group of bits indicates a different type of multicast-broadcast control channel change.

Example 18: The method of example 17, wherein the multicast-broadcast control channel change indicated by the group of bits comprises a start of a new multicast-broadcast session, an addition of a multicast-broadcast service, an indication of a multicast-broadcast service update, or any combination thereof.

Example 19: The method of any one of examples 15 through 18, wherein the content change information indicates a start of a multicast-broadcast session, a change in multicast-broadcast control channel content or service, or both.

Example 20: The method of any one of examples 15 through 19, further comprising: identifying a change to a multicast service or a broadcast service based at least in part on the multicast-broadcast control channel change notification; and determining whether to transition to the connected state or to remain in the first state to receive the change based at least in part on the multicast service or the broadcast service.

Example 21: The method of any one of examples 1 through 20, further comprising: monitoring a group-radio network temporary identifier or paging radio network temporary identifier associated with the trigger message; and identifying the trigger message associated with the one or more multicast services based at least in part on the monitoring.

Example 22: A method for wireless communications at a base station, comprising: identifying that a user equipment (UE) is operating in accordance with a first state, wherein the first state is either a RRC-inactive state or a RRC-idle state; and transmitting a trigger message to the UE that indicates that one or more multicast services are available for use by the UE while the UE is in a connected state.

Example 23: The method of example 22, further comprising: determining scheduling information for a plurality of occasions for transmitting the trigger message to the UE in a physical downlink control channel, wherein the trigger message comprises a RRC paging message indicating the one or more multicast services; and transmitting, to the UE, downlink control information indicating the scheduling information.

Example 24: The method of example 23, further comprising: transmitting the RRC paging message in accordance with the scheduling information, the RRC paging message including a first field in that indicates a multicast group paging identity associated with the one or more multicast services.

Example 25: The method of example 24, wherein the first field comprises a paging record type field comprising a UE specific paging record, a multicast group specific paging record, or both.

Example 26: The method of any one of examples 24 through 25, wherein the multicast group paging identity comprises a group radio network temporary identifier, a temporary mobile group identity, a multicast-broadcast session identifier, or any combination thereof.

Example 27: The method of any one of examples 24 through 26, further comprising: transmitting, in the RRC paging message, a service type indication associated with the one or more multicast services based at least in part on the multicast group paging identity.

Example 28: The method of any one of examples 23 through 27, further comprising: transmitting the RRC paging message in accordance with the scheduling information, the RRC paging message comprising a paging identifier that includes a paging record and a multicast session identifier associated with the UE.

Example 29: The method of any one of examples 23 through 28, further comprising: transmitting a one-bit indicator in the downlink control information, wherein the one-bit indicator comprises a notification that the one or more multicast services are scheduled.

Example 30: The method of any one of examples 22 through 29, further comprising: transmitting an indication that the trigger message is included with the downlink control information in a physical downlink control channel, wherein the trigger message comprises a short message that indicates the one or more multicast services.

Example 31: The method of example 30, further comprising: configuring a plurality of reserved bits in the short message, wherein a value of one or more bits of the plurality of reserved bits indicates the one or more multicast services available to the UE.

Example 32: The method of example 31, further comprising: configuring a single reserved bit in the short message, wherein a value of the single reserved bit indicates a multicast service available to the UE.

Example 33: The method of any one of examples 31 through 32, further comprising: configuring a set of reserved bits in the short message, wherein the set of reserved bits indicates a multicast service or a group of multicast services based at least in part on a value of the set of reserved bits.

Example 34: The method of example 33, further comprising: transmitting a RRC message that indicates a mapping between the value of the set of reserved bits and a plurality of different multicast services or groups of multicast services.

Example 35: The method of any one of examples 22 through 34, further comprising: transmitting the trigger message in a SIB, the SIB including a multicast-broadcast control channel configuration.

Example 36: The method of example 35, further comprising: transmitting a multicast-broadcast control channel change notification during a multicast-broadcast control channel modification period, wherein the multicast-broadcast control channel change notification indicates content change information for the multicast-broadcast control channel.

Example 37: The method of example 36, wherein the multicast-broadcast control channel change notification comprises a downlink control information message scrambled with a multicast-broadcast control channel radio network temporary identifier, a medium access control message, a SIB, or any combination thereof.

Example 38: The method of example 37, wherein the multicast-broadcast control channel change notification further comprises a single bit or a group of bits in the downlink control information message, each bit of the group of bits indicates a different type of multicast-broadcast control channel change.

Example 39: The method of example 38, wherein the multicast-broadcast control channel change indicated by the group of bits comprises a start of a new multicast-broadcast session, an addition of a multicast-broadcast service, an indication of a multicast-broadcast service update, or any combination thereof.

Example 40: The method of any one of examples 36 through 39, wherein the content change information indicates a start of a multicast-broadcast session, a change in multicast-broadcast control channel content or service, or both.

Example 41: The method of any one of examples 36 through 40, further comprising: identifying a change to a multicast service or a broadcast service; and transmitting, to the UE, an indication of the change in the multicast-broadcast control channel change notification.

Example 42: The method of one of examples 22 through 41, further comprising: transmitting, to the UE, a group radio network temporary identifier or paging radio network temporary identifier associated with identifying the trigger message.

Example 43: An apparatus for wireless communications at a user equipment (UE) comprising at least one means for performing a method of any one of examples 1 through 21.

Example 44: An apparatus for wireless communications at a user equipment (UE) comprising a processor and memory coupled to the processor, the processor and memory configured to perform a method of any one of examples 1 through 21.

Example 45: A non-transitory computer-readable medium storing code for wireless communications at a user equipment (UE) the code comprising instructions executable by a processor to perform a method of any one of examples 1 through 21.

Example 46: An apparatus for wireless communications at a base station comprising at least one means for performing a method of any one of examples 22 through 42.

Example 47: An apparatus for wireless communications at a base station comprising a processor and memory coupled to the processor, the processor and memory configured to perform a method of any one of examples 22 through 42.

Example 48: A non-transitory computer-readable medium storing code for wireless communications at a base station the code comprising instructions executable by a processor to perform a method of any one of examples 22 through 42.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
identifying that the UE is operating in accordance with a first state, wherein the first state is either a radio resource control-inactive state or a radio resource control-idle state;
receiving, in downlink control information, scheduling information that indicates one or more occasions for receiving a trigger message in a physical downlink shared channel, wherein the trigger message comprises a radio resource control paging message indicating that one or more multicast services are available for use by the UE while the UE is in a connected state;
receiving the trigger message based at least in part on the scheduling information; and
determining whether to transition from the first state to the connected state to receive the one or more multicast services based at least in part on the trigger message.

2. The method of claim 1, further comprising:
receiving the radio resource control paging message in accordance with the scheduling information;
identifying a first field in the radio resource control paging message that indicates a multicast group paging identity associated with the one or more multicast services; and
transitioning to the connected state to receive the one or more multicast services based at least in part on the multicast group paging identity.

3. The method of claim 2, wherein the first field comprises a paging record type field comprising a UE specific paging record, a multicast group specific paging record, or both.

4. The method of claim 2, wherein the multicast group paging identity comprises a group-radio network temporary identifier, a temporary mobile group identity, a multicast-broadcast session identifier, or any combination thereof.

5. The method of claim 2, further comprising:
identifying, in the radio resource control paging message, a service type indication associated with receiving the one or more multicast services based at least in part on the multicast group paging identity.

6. The method of claim 1, further comprising:
receiving the radio resource control paging message in accordance with the scheduling information;
identifying a paging identifier in the radio resource control paging message,
wherein the paging identifier comprises a paging record and a multicast session identifier associated with the UE; and
transitioning to the connected state to receive the one or more multicast services based at least in part on the paging identifier.

7. The method of claim 1, further comprising:
determining that the scheduling information is scheduling the one or more multicast services based at least in part on a value of a one-bit indicator received in the downlink control information.

8. The method of claim 1, further comprising:
receiving the trigger message in a system information block, the system information block comprising a multicast-broadcast control channel configuration; and
determining whether to receive the one or more multicast services on a multicast-broadcast control channel in accordance with the first state or the connected state based at least in part on the multicast-broadcast control channel configuration.

9. The method of claim 8, further comprising:
receiving a multicast-broadcast control channel change notification during a multicast-broadcast control channel modification period, wherein the multicast-broadcast control channel change notification indicates content change information for the multicast-broadcast control channel; and
monitoring the multicast-broadcast control channel for the content change information based at least in part on the multicast-broadcast control channel change notification.

10. The method of claim 9, wherein the content change information indicates a start of a multicast-broadcast session, a change in multicast-broadcast control channel content or service, or both.

11. The method of claim 9, wherein the multicast-broadcast control channel change notification comprises a downlink control information message scrambled with a multicast-broadcast control channel radio network temporary identifier, a medium access control message, a system information block, or any combination thereof.

12. The method of claim 9, wherein the multicast-broadcast control channel change notification further comprises a single bit or a group of bits in a downlink control information message, wherein each bit of the group of bits indicates a different type of multicast-broadcast control channel change.

13. The method of claim 9, wherein the multicast-broadcast control channel change notification indicated by a group of bits comprises a start of a new multicast-broadcast session, an addition of a multicast-broadcast service, an indication of a multicast-broadcast service update, or any combination thereof.

14. The method of claim 9, further comprising:
identifying a change to a multicast service or a broadcast service based at least in part on the multicast-broadcast control channel change notification; and
determining whether to transition to the connected state or to remain in the first state to receive the change based at least in part on the multicast service or the broadcast service.

15. The method of claim 1, further comprising:
receiving, in the downlink control information, an indication that the trigger message is included with the downlink control information in a physical downlink control channel, wherein the trigger message comprises a short message that indicates the one or more multicast services.

16. The method of claim 15, further comprising:
identifying a plurality of reserved bits associated with the short message;
determining a value of one or more bits of the plurality of reserved bits, wherein the value of the one or more bits indicates the one or more multicast services; and
transitioning to the connected state to receive the one or more multicast services based at least in part on the value of the one or more bits.

17. The method of claim 16, further comprising:
determining the one or more bits comprises a single reserved bit associated with the short message; and
transitioning to the connected state to receive the one or more multicast services based at least in part on a value of the single reserved bit.

18. The method of claim 16, further comprising:
determining the one or more bits comprises a set of reserved bits associated with the short message;
identifying a multicast service or a group of multicast services of the one or more multicast services based at least in part on a value of the set of reserved bits; and
transitioning to the connected state to receive the multicast service or the group of multicast services based at least in part on the value of the set of reserved bits.

19. The method of claim 18, wherein identifying the multicast service or the group of multicast services further comprises:
receiving a radio resource control message indicating a mapping between the value of the set of reserved bits and a plurality of different multicast services or groups of multicast services.

20. The method of claim 1, further comprising:
monitoring a group-radio network temporary identifier or paging radio network temporary identifier associated with the trigger message; and
identifying the trigger message associated with the one or more multicast services based at least in part on the monitoring.

21. A method for wireless communications, comprising:
identifying that a user equipment (UE) is operating in accordance with a first state, wherein the first state is either a radio resource control-inactive state or a radio resource control-idle state; and
transmitting, in downlink control information, scheduling information for one or more occasions for transmitting a trigger message to the UE in a physical downlink control channel, wherein the trigger message comprises a radio resource control paging message indicating that one or more multicast services are available for use by the UE while the UE is in a connected state.

22. The method of claim 21, further comprising:
transmitting the radio resource control paging message in accordance with the scheduling information, the radio resource control paging message including a first field in that indicates a multicast group paging identity associated with the one or more multicast services.

23. The method of claim 22, wherein the first field comprises a paging record type field comprising a UE specific paging record, a multicast group specific paging record, or both.

24. The method of claim 22, wherein the multicast group paging identity comprises a group radio network temporary identifier, a temporary mobile group identity, a multicast-broadcast session identifier, or any combination thereof.

25. The method of claim 22, further comprising:
transmitting, in the radio resource control paging message, a service type indication associated with the one or more multicast services based at least in part on the multicast group paging identity.

26. The method of claim 21, further comprising:
transmitting the radio resource control paging message in accordance with the scheduling information, the radio resource control paging message comprising a paging identifier that includes a paging record and a multicast session identifier associated with the UE.

27. The method of claim 21, further comprising:
transmitting a one-bit indicator in the downlink control information, wherein the one-bit indicator comprises a notification that the one or more multicast services are scheduled.

28. The method of claim 21, further comprising:
transmitting the trigger message in a system information block, the system information block including a multicast-broadcast control channel configuration.

29. An apparatus for wireless communications, comprising:
a processor,
memory coupled with the processor; and
instructions stored in the memory and executable by the processor to cause the apparatus to:
identify that a user equipment (UE) is operating in accordance with a first state, wherein the first state is either a radio resource control-inactive state or a radio resource control-idle state;
receive, in downlink control information, scheduling information that indicates one or more occasions for receiving a trigger message in a physical downlink shared channel, wherein the trigger message comprises a radio resource control paging message indicating that one or more multicast services are available for use by the UE while the UE is in a connected state;
receive the trigger message based at least in part on the scheduling information; and
determine whether to transition from the first state to the connected state to receive the one or more multicast services based at least in part on the trigger message.

30. An apparatus for wireless communications, comprising:
a processor,
memory coupled with the processor; and
instructions stored in the memory and executable by the processor to cause the apparatus to:
identify that a user equipment (UE) is operating in accordance with a first state, wherein the first state is either a radio resource control-inactive state or a radio resource control-idle state; and
transmitting, in downlink control information, scheduling information for one or more occasions for transmitting a trigger message to the UE in a physical downlink control channel, wherein the trigger message comprises a radio resource control paging message indicating that one or more multicast services are available for use by the UE while the UE is in a connected state.
